(19) United States
(12) Patent Application Publication
(10) Pub. No.: US 2009/0307066 A1
(43) Pub. Date: Dec. 10, 2009

(54) COUPON DISPENSING METHODS AND SYSTEMS

(75) Inventors: John Lonsbury, Edina, MN (US); Mark Lonsbury, Minneapolis, MN (US)

Correspondence Address: SCHWEGMAN, LUNDBERG & WOESSNER, P.A., P.O. BOX 2938, MINNEAPOLIS, MN, 55402, US

(73) Assignee: Interactive Marketing, Incorporate, Edina, MN (US)

(21) Appl. No.: 12/333,058

(22) Filed: Dec. 11, 2008

Related U.S. Application Data
(60) Provisional application No. 61/007,158, filed on Dec. 11, 2007.

(51) Int. Cl. G06Q 30/00

(52) U.S. Cl. 705/14.1

(57) ABSTRACT

A coupon dispensing system is provided, and includes a plurality of dispensing devices located in retail establishments, wherein each dispensing device includes a kiosk unit. The kiosk unit includes a processing unit, a touch screen display, a modem and/or network connection, and a storage device. Also provided is a control system capable of exchanging information with the dispensing devices, wherein the control system includes software operable to maintain library of coupon offerings, send coupon offering information to dispensing devices, collect and operate on data received from coupon dispensing devices, provide a web interface accessible over the Internet to provide for viewing of selected dispensing system data. Also provided is a coupon offering authoring tool to prepare coupon offering data to be used to display coupon offerings by the dispensing devices.

### CLAIM OF PRIORITY

This patent application claims the benefit of priority, under 35 U.S.C. Section 119(e), to Lonsbury et al. U.S. Provisional Patent Application Ser. No. 61/007,158, entitled “COUPON DISPENSING METHODS AND SYSTEMS,” filed on Dec. 11, 2007 (Attorney Docket No. 1888.003PRV).

### TECHNICAL FIELD OF THE INVENTION

The present invention pertains generally to programmed computers and more particularly to methods, articles and apparatus for dispensing coupons.

### BACKGROUND OF THE INVENTION

Product or service redemption coupons are regularly used by millions of consumers who realize substantial savings as a result. One use of product redemption coupons is to entice consumers to try new products in the hope that, after the first try of a new product at a coupon discounted price, they would become repeat customers at the regular price. Coupons are effective tools used in launching new products. Manufacturers also find coupons can shore up flagging sales, help reduce excess inventory or win back consumers' brand loyalty. As a result, coupons for existing products have become customary, so much so that today's consumers have come to expect coupons. The competitive nature of the retail industry does not allow manufacturers to reduce coupon distribution, and in some market sectors, such as cereals, the majority of purchases are made with coupons.

Coupons are delivered to consumers through a variety of media. The primary coupon distribution is via pull-out sections in newspapers, which are known as free standing inserts (FSIs). By some estimates, these FSI coupons account for over one half of coupons used. Other methods of distribution include in-store shelf coupon dispensers, check-out coupons (generally issued based on the customer's current purchase), register receipt coupons, in-product coupons, instant peel-off on-product coupons and direct mail coupons. In addition to manufacturers' coupons, consumers use retail store coupons, such as those issued by large retail chains, on a weekly basis.

Some consumers use coupons on a fairly random basis. These consumers tend not to keep coupons for future use, but will review coupons available just prior to shopping to see if any of them cover products they plan to buy or if there are any for new or improved products of interest. More organized coupon users maintain some form of storage system to keep coupons for future use. These consumers often clip coupons regularly from all available sources, and often have coupon-filing systems by product category. They will also review their coupons regularly, discarding unused coupons, which have expired.

For most consumers, attempts to maintain an organized coupon file often fail. The “bother” and time required to maintain organized coupon files often results in neglect of those files, even though diligent shoppers know that a consistent significant savings is easily achievable using coupons.

On average, manufacturers who use FSIs for coupon distribution, the largest percentage of coupons distributed, spend nearly one dollar per coupon redeemed, which is the lowest redeemed cost per coupon redeemed when compared with other current coupon distribution methods. FSI coupon distribution results in high costs per coupon because of the shear complexity of and volume of materials involved in coupon distribution and redemption. Charges to manufacturers by FSI producers cover set-up, paper, printing, freight, newspaper insertion costs, sales and marketing, overhead and profit.

Direct mail coupons, Run-of-Press (“ROP”) Coupons, in/on pack coupons are other forms of coupon distribution. Two other important coupon distribution methods include shelf distribution and custom prepared coupon distribution. Thousands of stores use coupon dispensers, which are attached to a product's shelf Customers can pull out one coupon from the dispenser for the product advertised. This method of coupon distribution is designed to reach the consumer at the point of making a purchase decision, and has a relatively high redemption rate. Another approach is check-out coupons that are printed at the check-out by a printer installed at the cash register. A computer analyzes the purchases made by each customer, and can print competitor's coupons or other coupons related to items in the current purchase.

As demonstrated above, the coupon industry expends a great deal of resources in market research, printing, issuing, distributing and redeeming coupons, yet produces an extremely low redemption rate. This is attributed to the haphazard systems used by most consumers of manually clipping, filing, sorting through, and ultimately using the coupons, and to the high cost associated with targeting coupons to each consumer.

### BRIEF DESCRIPTION OF THE DRAWING

FIGS. 1-43B illustrate various alternate embodiments of the inventive subject matter disclosed herein.

### DETAILED DESCRIPTION OF THE INVENTION

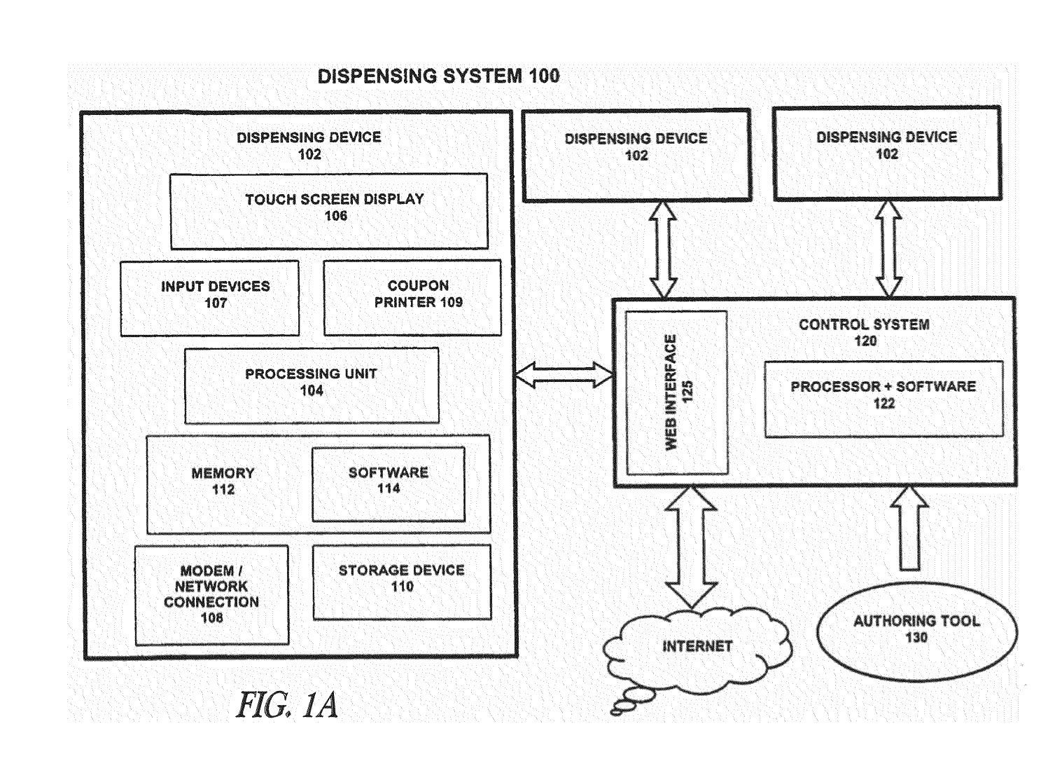

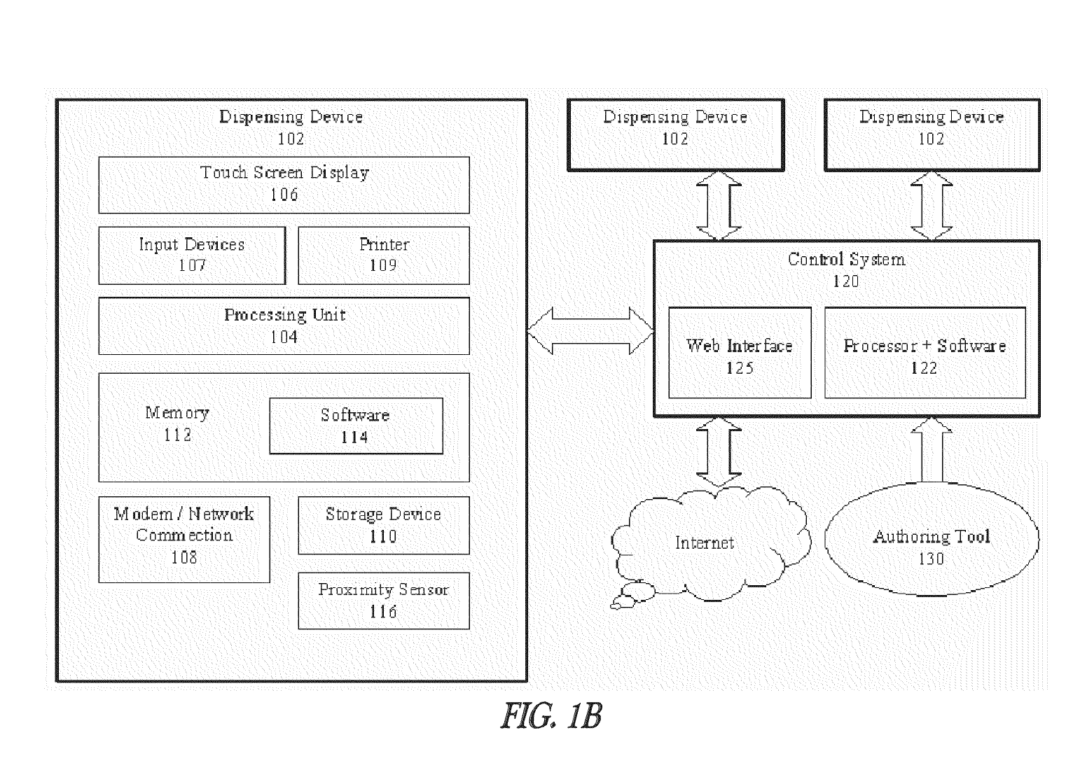

Referring now to FIG. 1A there is illustrated a block diagram of a coupon dispensing system 100 according to one example embodiment of the inventive subject matter presented herein. A plurality of dispensing devices 102 are located in retail establishments, wherein each dispensing device takes the form of a kiosk unit including one or more processing units 104, one or more touch screen display(s) 106, one or more input devices 107, one or more modems and/or network connections 108, one or more coupon printers 109, a storage device 110, memory 112 and software 114 executable on the processing units 104 and stored in the storage devices 110, memory 112 or in another storage locations on device 102. It is noted that the term “retail establishment” as used herein means any establishment in which a product or service is offered to consumers of those products or services. A retail establishment may be, for example and without limitation, a grocery store, a deli, a restaurant, a movie theater, a clothing store, a hardware store, a service station or a fast food restaurant.

There is further provided a control system 120 capable of exchanging information with the dispensing devices 102, wherein the control system includes software 122 operable on a control system processor or processors 122 to maintain a library of coupon offerings, send coupon offering information to dispensing devices, collect and operate on data received from coupon dispensing devices, and provide a web interface 125 accessible over the Internet to provide for viewing of selected dispensing system data. Also provided is a coupon offering authoring tool 130 to prepare coupon offering data to be used to display coupon offerings by the dispensing devices. Authoring tool 130 comprises software operable on a control system processor 122 or on a separate processor found on a PC or other computer work station.

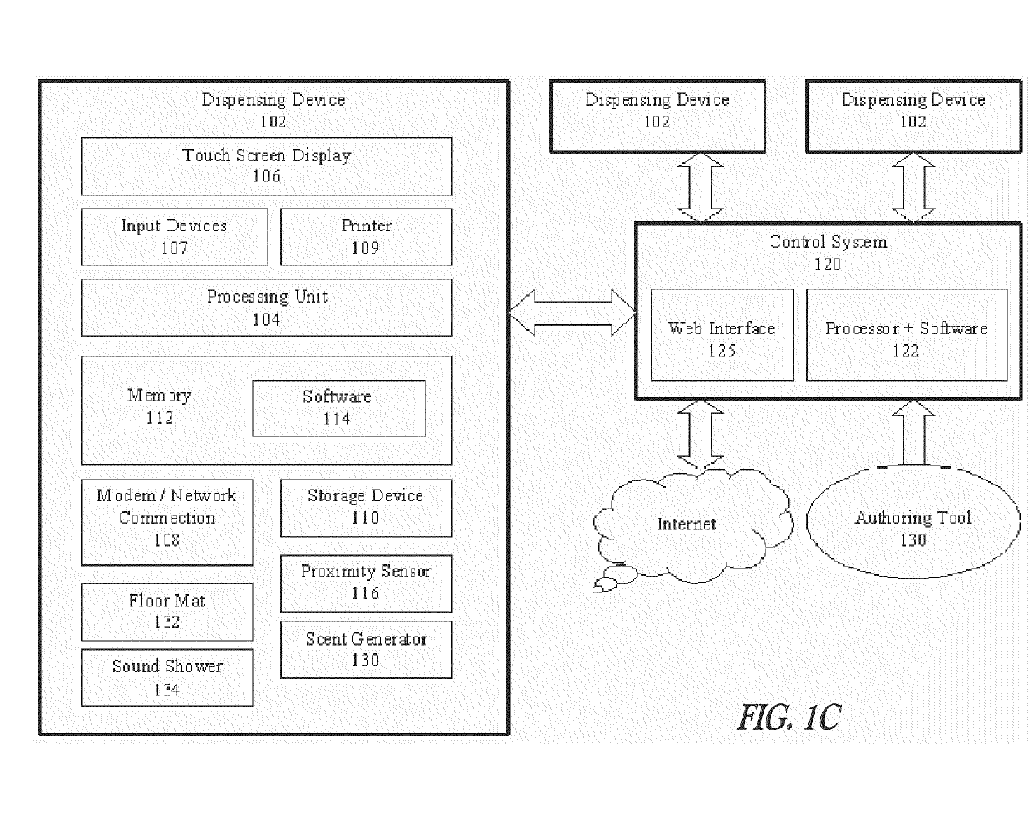

Referring now to FIGS. 2A (top plan view) and 2B (side elevation view) there is illustrated one example embodiment of a dispensing device 200. Device 200 is, in this embodiment, a kiosk available from IBM Corporation (model 152), and, referring to FIG. 2B, includes a physical housing including a lower base or pedestal portion 202 and top housing portion 204 that houses a touch screen display 206a. Device 200 includes dispensing system components such as those described above including a touch screen display 206 and a printer 208a (represented in dotted line) mounted in the housing with slot 208b providing an opening through which printed coupons can be dispensed from the printer. Dispenser 200 is, in the embodiment shown, a four-sided kiosk, and includes three additional touch screens 206b, 206c, and 206d, on the other sides, as seen in FIG. 7A. Also included but not shown are corresponding printers for each side, so that four coupon dispensing stations are provided. In this embodiment, one or more computer systems or servers 210 may be provided in base or pedestal 202 in order to operate the touch screens and associated printers.

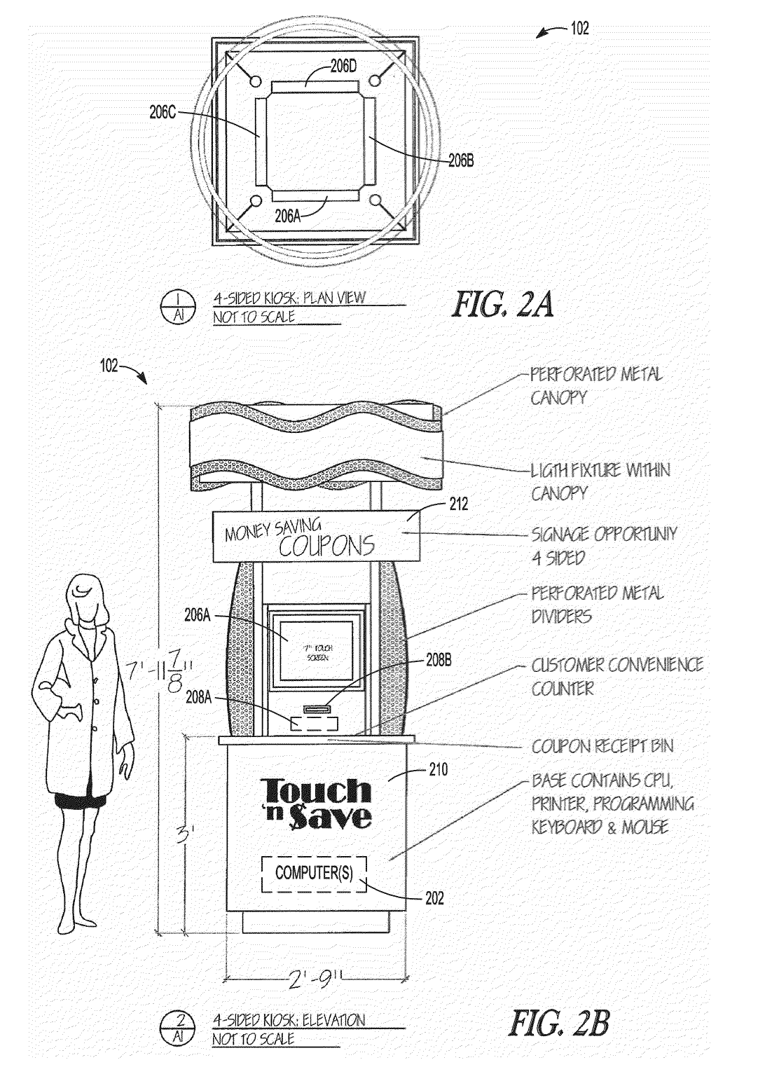

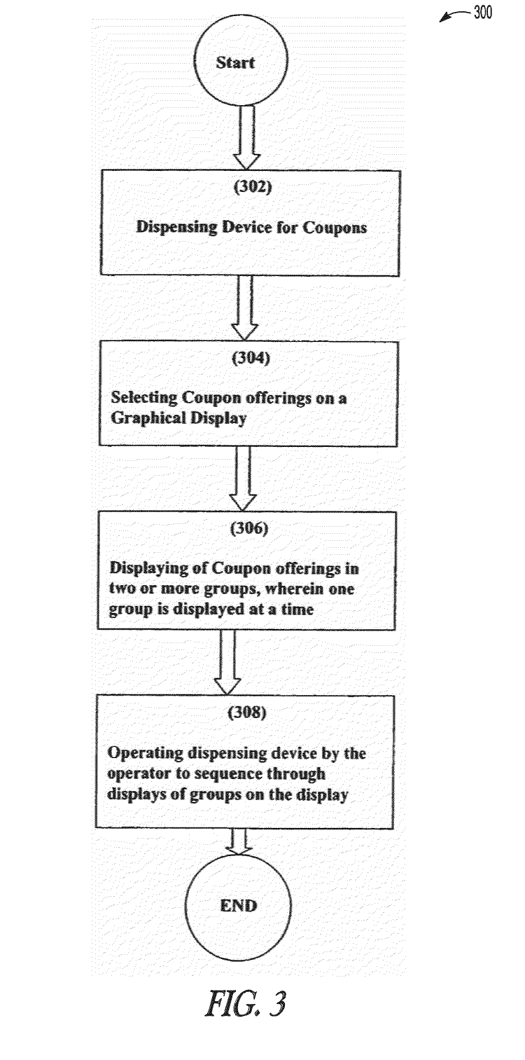

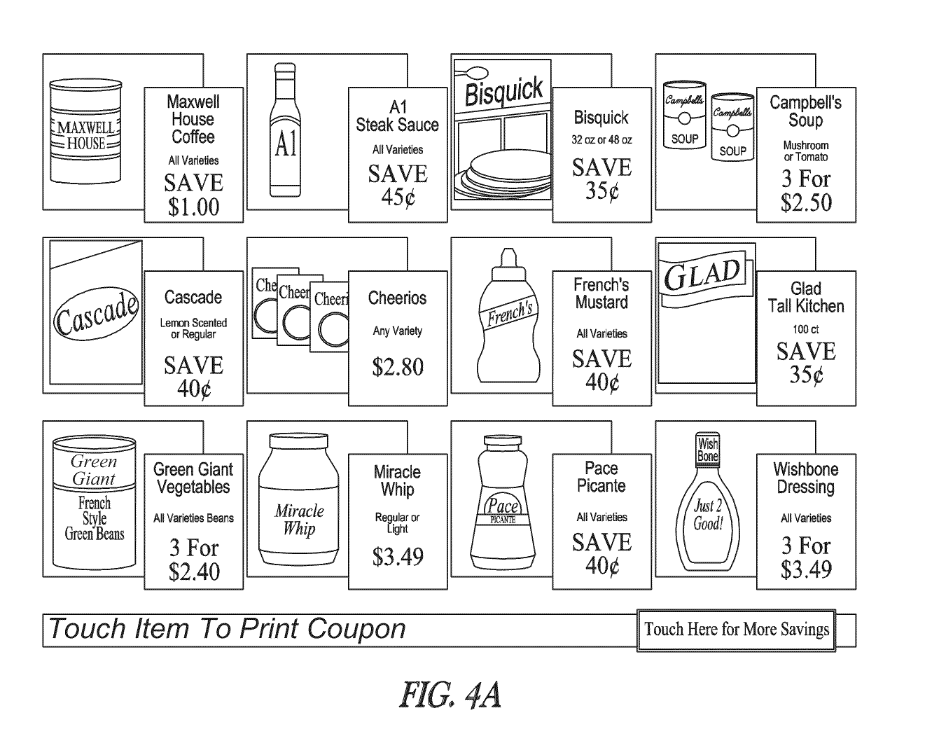

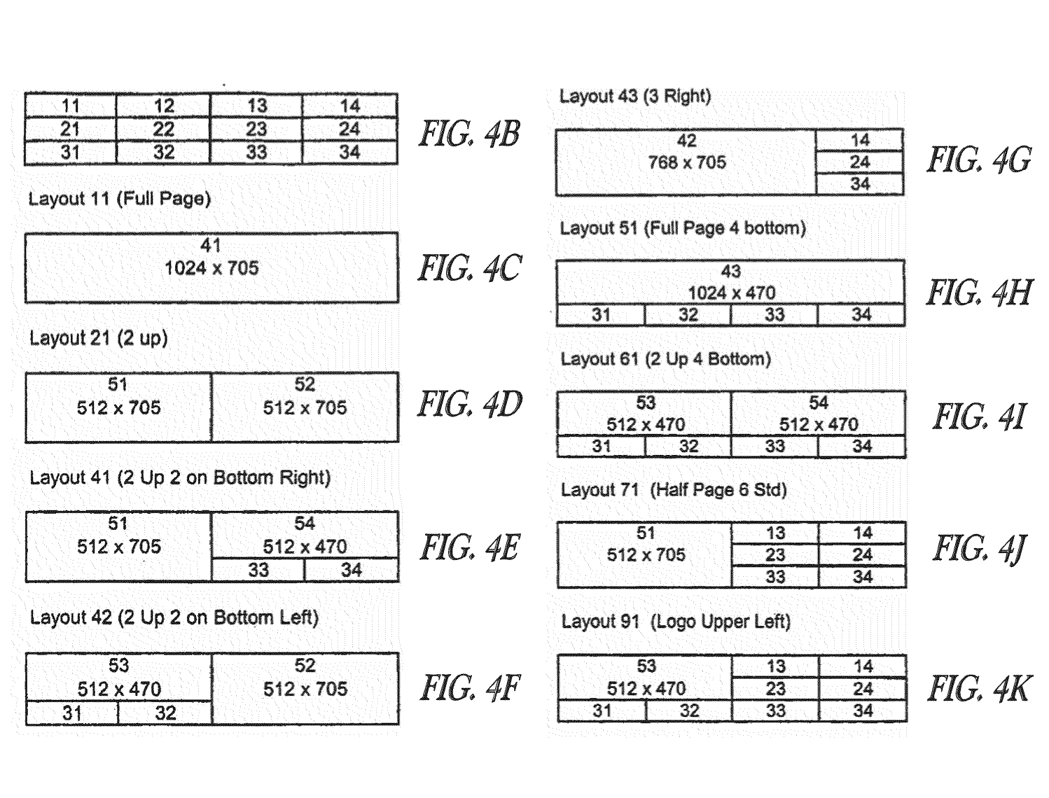

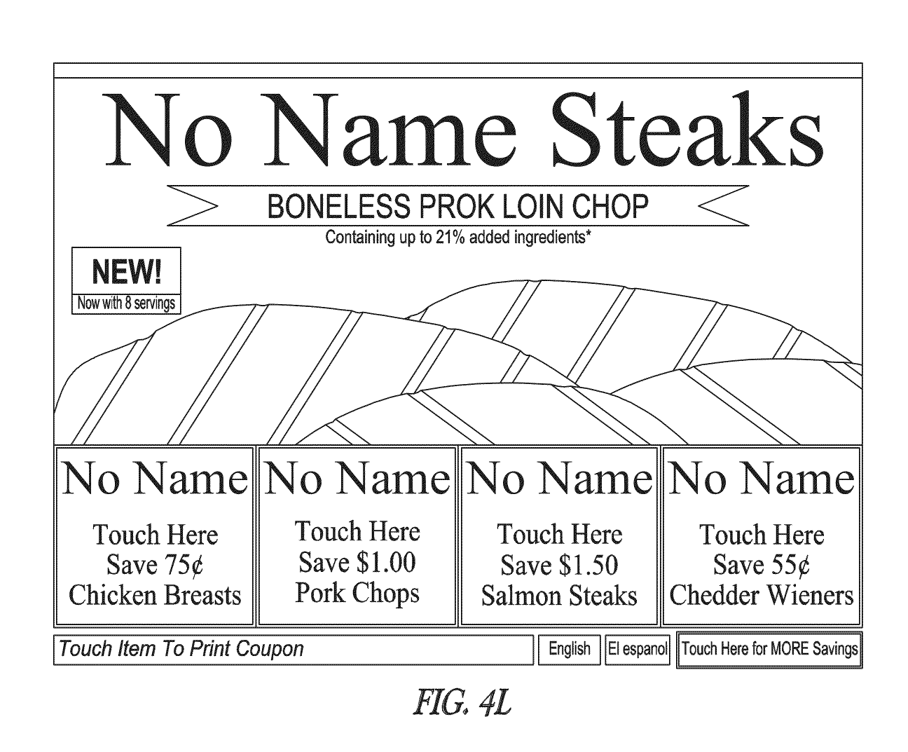

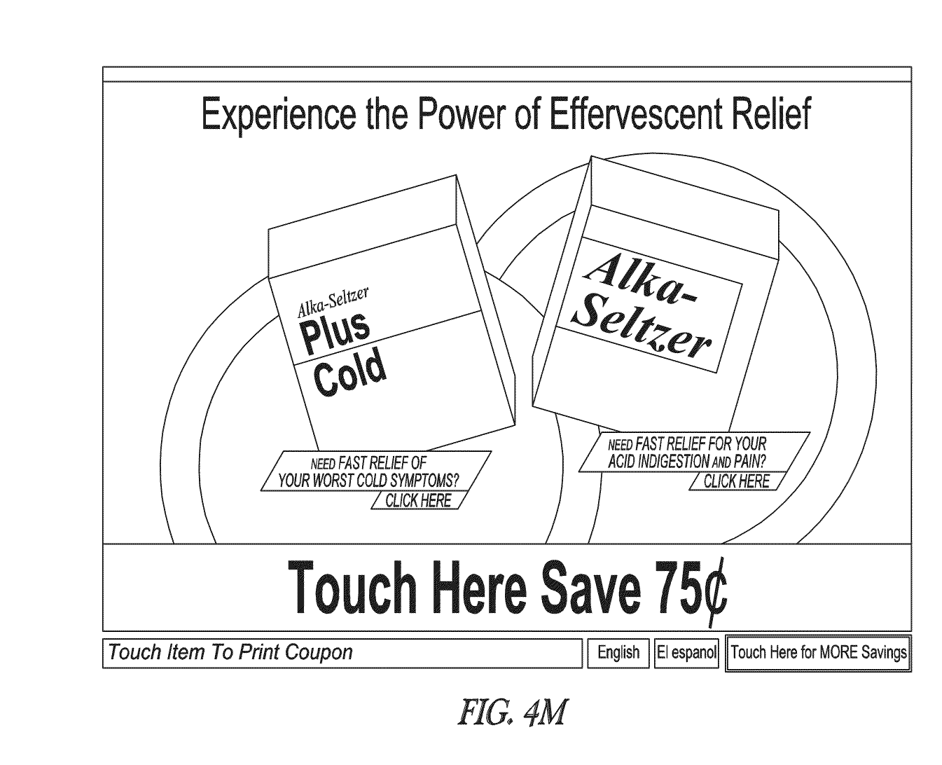

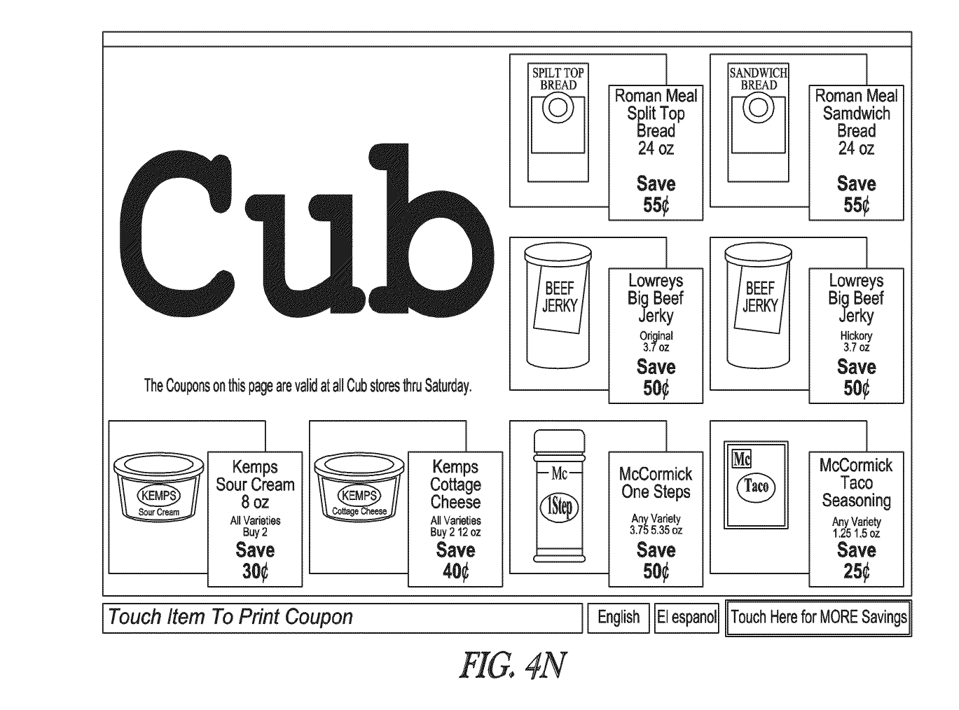

Turning now to FIGS. 3-18, there are described a number of example embodiments of methods for coupon dispensing according the inventive subject matter described here. Referring now to the flow chart diagram of FIG. 3, there is shown a first example embodiment of a method 300 according to the inventive subject matter described herein. According to this method, a coupon dispensing device is located in a retail establishment, as depicted in block 302, such as but not limited to the coupon dispensing devices described above. The dispensing device displays a selection of coupon offerings on a graphical display, as depicted in block 304, such as those shown in FIGS. 4A, 4B, 4C, 4D, 4E, 4F, 4G, 4H, 4I, 4J and 4K. FIGS. 4A and 4B illustrate a screen display with 12 coupons displayed on it in three rows of 4 coupons. FIGS. 4C through 4K show additional layouts for coupon display, where row and column is indicated by the number of the display area, and example pixel sizes are given for some areas. In the display of FIG. 4G, for example, selecting one of the coupons displayed on the right side (Spots 14, 24, 34) causes Spot 42 to display full size the selected coupon. According to this method, the coupons are for goods or services offered for sale at the retail establishment. As depicted in block 306, the coupon offerings are displayed in two or more groups, wherein one group is displayed at a time. As shown in block 308, a consumer operates the dispensing device to sequence through displays of groups on the display. For example, sequence from group 402 to group 404 to group 406.

The flow chart diagram of FIG. 5 shows another example embodiment of a method 500 according to the inventive subject matter described herein. In this method, block 502 depicts a coupon dispensing device located in a retail establishment, such as but not limited to the coupon dispensing devices described above. According to this method, the dispensing device displays a selection of coupon offerings, such as those shown in FIG. 4A, 4B or 4C, on a graphical display, as depicted in block 504. According to this method, the coupons are for goods or services offered for sale at the retail establishment. As depicted in block 506, the coupon offerings are displayed in two or more groups 402, 404, 406, wherein one group is displayed at a time. As shown in block 508, a consumer operates the dispensing device to sequence through displays of groups on the display. For example, sequence from group 402 to group 404 to group 406. Further, as depicted in block 510, the offerings have an order in which those are displayed, and the order of the coupon offerings in which these are displayed, depends on time of the day. The order may also be manipulated by the software program based on several factors such as but not limited to past performance, incentive value or last offering selected.

The flow chart diagram of FIG. 6 provides another example embodiment of a method 600 according to the inventive subject matter described herein. In this method, block 602 depicts a coupon dispensing device located in a retail establishment, such as but not limited to the coupon dispensing devices described above. According to this method, the dispensing device displays a selection of coupon offerings on a graphical display, as depicted in block 304, such as those shown in FIG. 4A, et. seq. According to this method, the coupons are for goods or services offered for sale at the retail establishment. As depicted in block 606, the coupon offerings are displayed in two or more groups 402, 404, 406, wherein one group is displayed at a time. According to one example embodiment, there may be instances where there is only one group displayed and the customers will select from that group only. As shown in block 608, a consumer operates the dispensing device to sequence through displays of groups on the display. For example, sequence from group 402 to group 404 to group 406. As shown in block 614, the consumer selects one of the coupon offerings to print a coupon. Such selection may be done with a touch screen by pointing to the coupon, or by other selecting operation. Further, block 616 shows that following the selection of coupon offering, a related offering is displayed to entice the customer to select the related coupon offering.

The flow chart diagram of FIG. 7 shows another example embodiment of a method 700 according to the inventive subject matter described herein. In this method, block 702 depicts a coupon dispensing device located in a retail establishment, such as but not limited to the coupon dispensing devices described above. According to this method, the dispensing device displays a selection of coupon offerings on a graphical display, as depicted in block 704, such as those shown in FIG. 4A, 4B or 4C. According to this method, the coupons are for goods or services offered for sale at the retail establishment. As depicted in block 706, the coupon offerings are displayed in two or more groups 402, 404, 406, wherein one group is displayed at a time. As shown in block 708, a consumer operates the dispensing device to sequence through displays of groups on the display. For example, sequence from group 402 to group 404 to group 406. Further, as depicted in Block 718, the offerings have an order in which those are displayed, and the order of the coupon offerings in which these are displayed, depends on location of the device in the establishment.

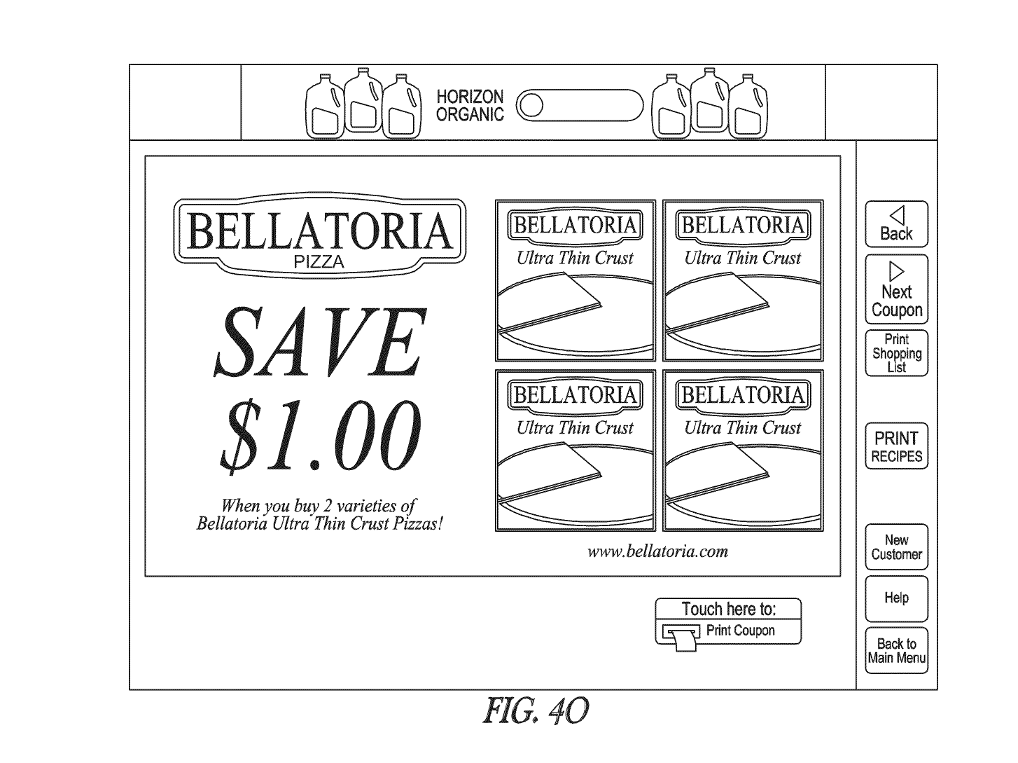

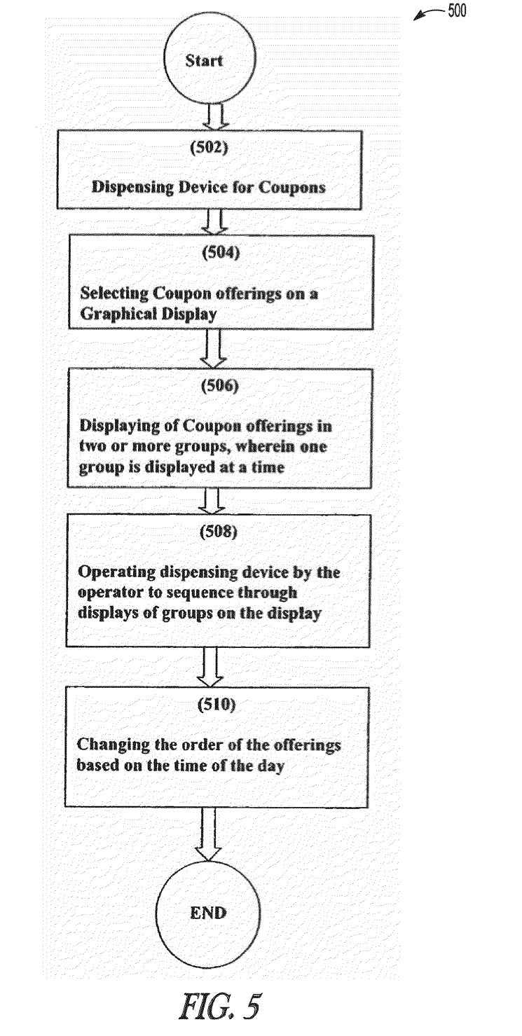

FIG. 8 is another example embodiment of the device. In this embodiment 800, a further block 820 permits substituting a different coupon offering for one of the coupon offerings based on the request of the retail establishment or a sponsor.

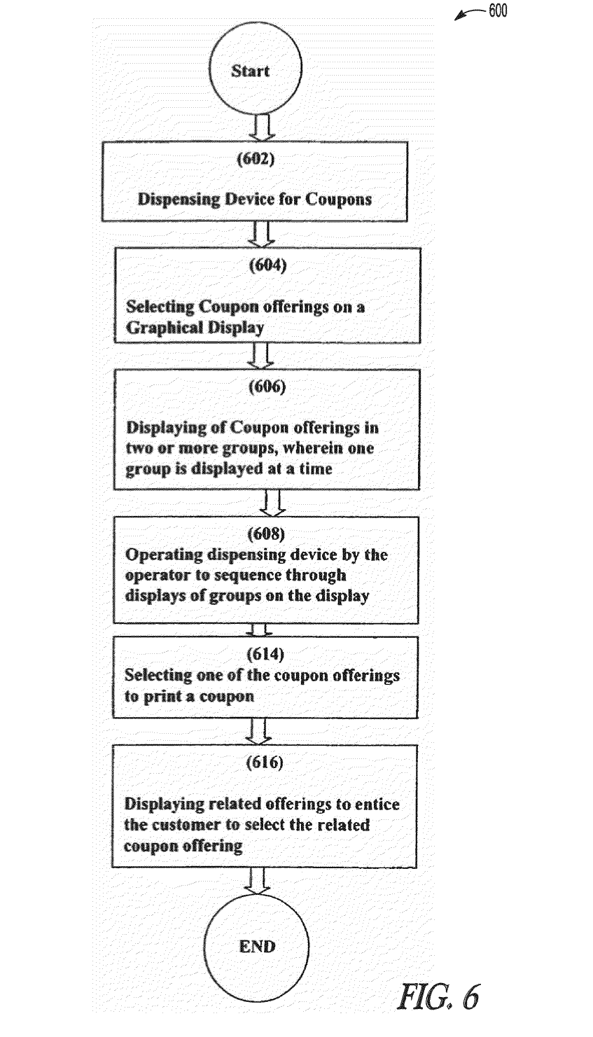

FIG. 9 is another similar example embodiment for the device. In this embodiment 900, a different block 922 permits stopping the display of a particular coupon offering based on the number of coupons printed for the particular coupon.

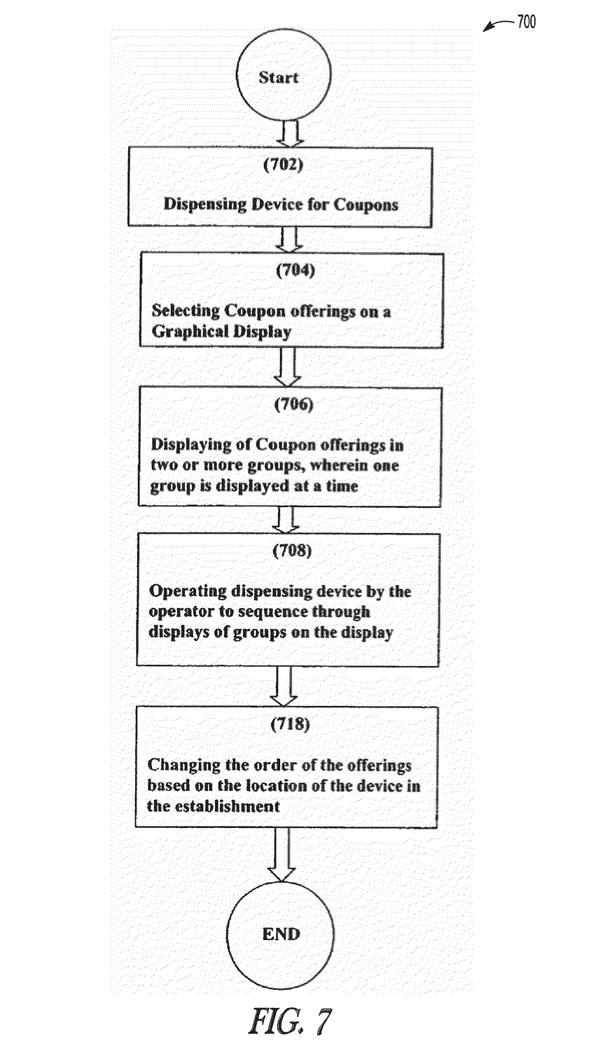

FIG. 10 is another example embodiment similar to that of FIG. 9. In this embodiment, another block 1024 depicts substituting a different coupon offering for the particular one for which the display was stopped.

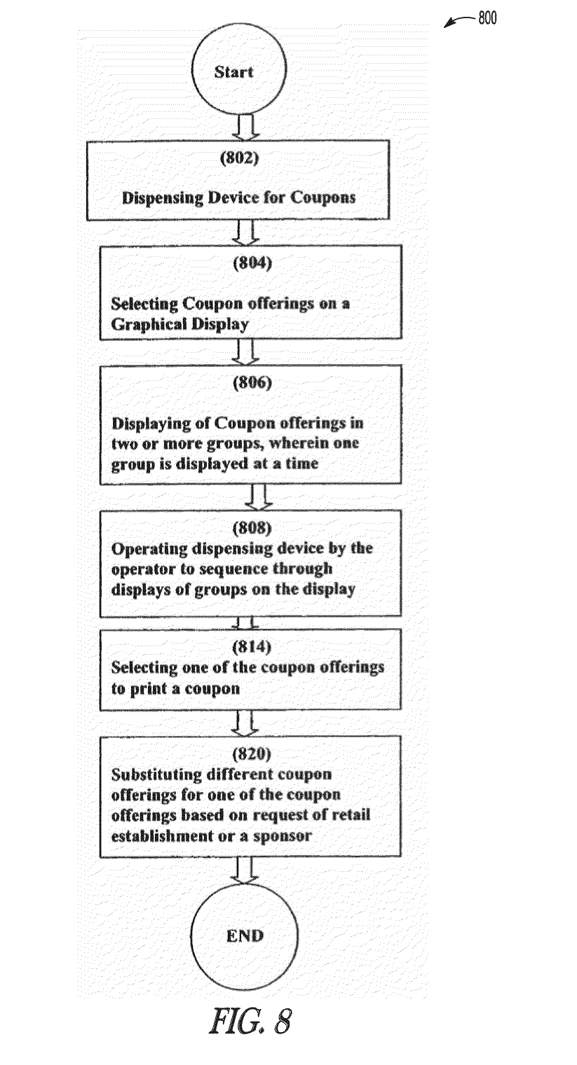

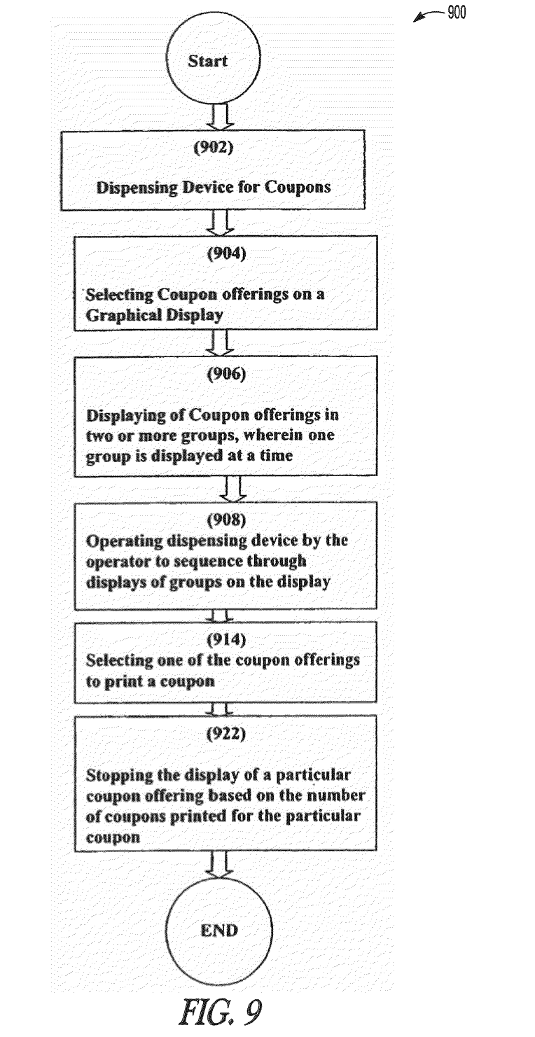

FIG. 11 is another example embodiment, and is similar to the embodiment of FIG. 6, with a different block 1126. The block 1126 permits printing one or more of related coupon offerings in addition to the selected coupon offering, to entice the customer.

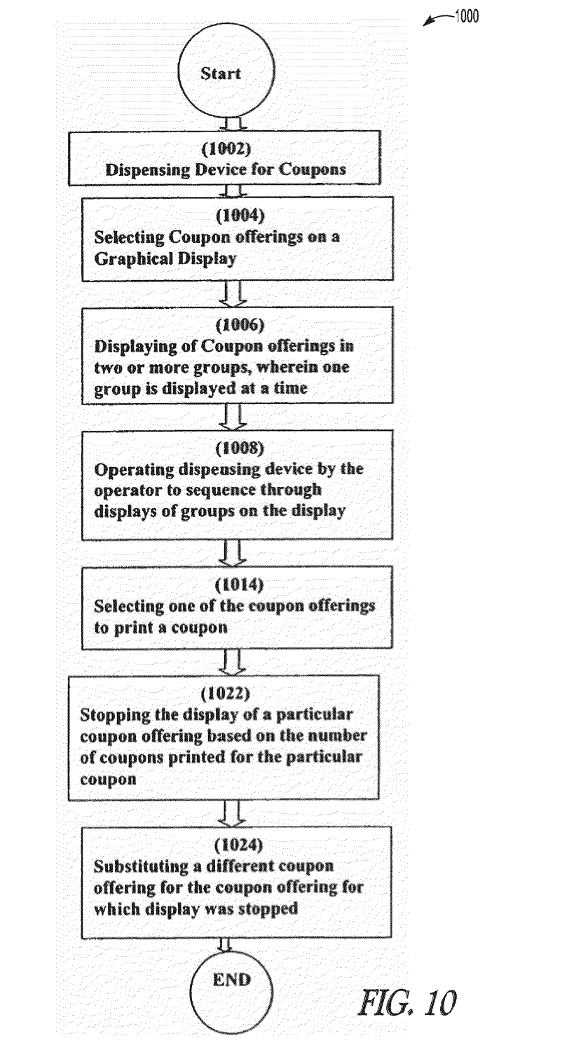

FIG. 12 is another example embodiment 1200 according to the inventive subject matter disclosed herein. A computerized device depicted by block 1228 is used for receiving electronic orders for the consumer food service choice in a food service establishment. According to this method, following entry of consumer's food choice, a selection of coupon offerings are displayed on a graphical display, as depicted in block 1204, such as those shown in FIG. 4A, 4B or 4C. According to this method, as depicted by block 1230, the coupons are for goods or services offered for sale at the food service establishment, and are related to the food choice made by the consumer. As shown in block 1208, a consumer operates the dispensing device. As shown in block 1214, the consumer selects one of the coupon offerings to print a corresponding coupon.

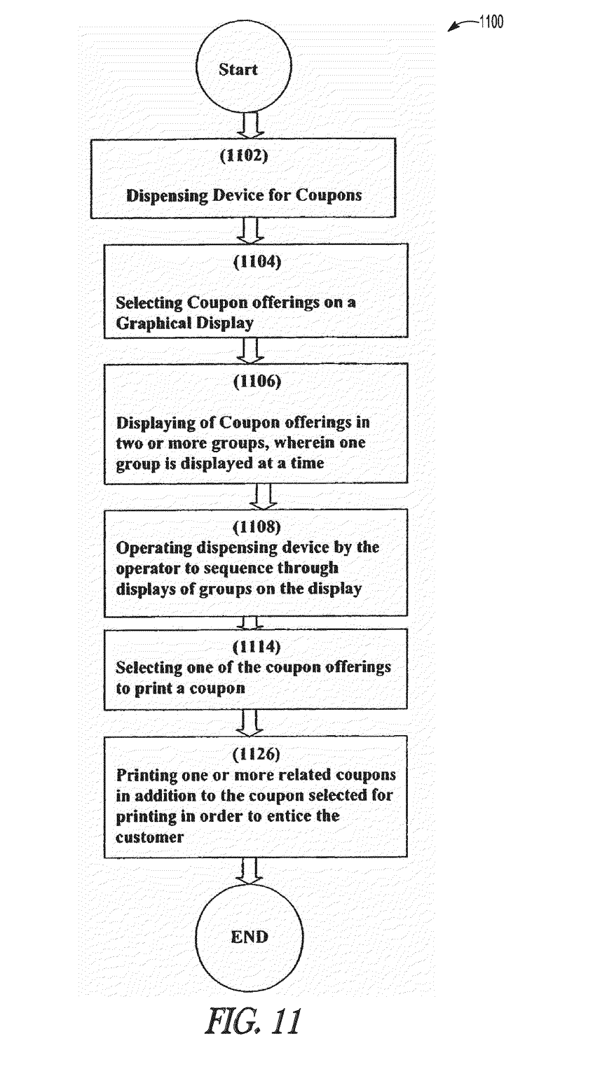

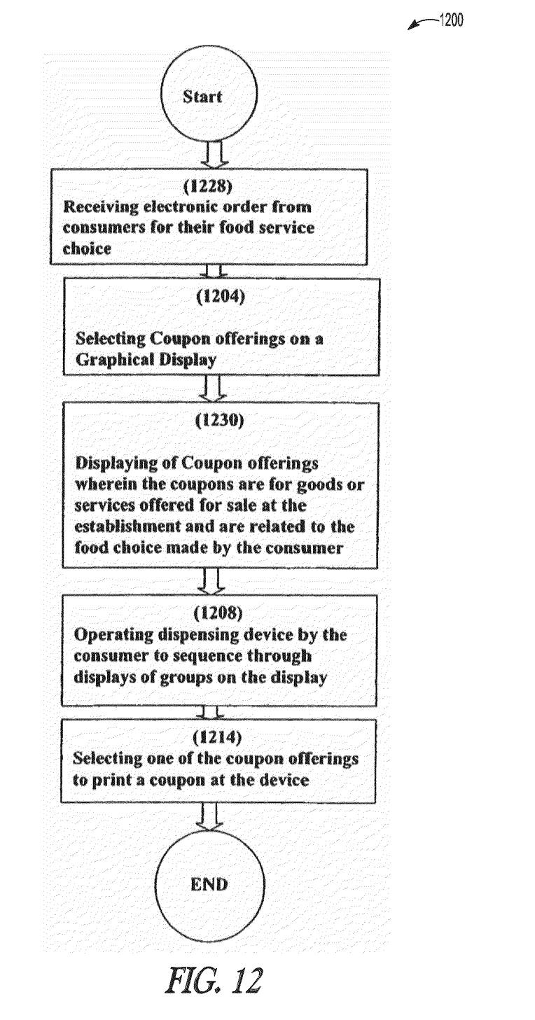

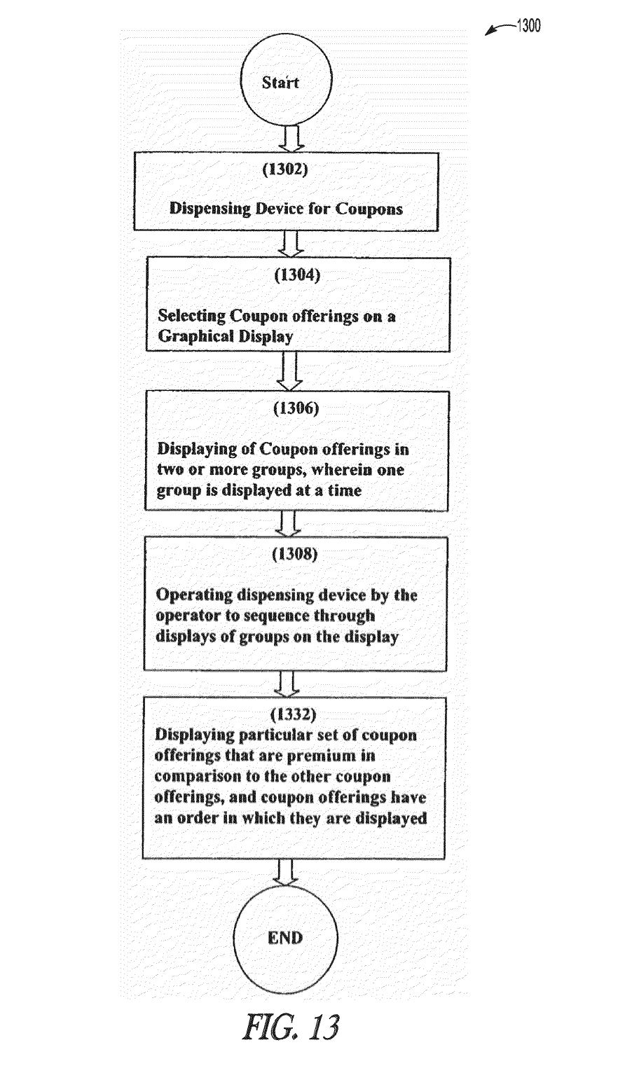

FIG. 13 is yet another embodiment of the inventive matter under consideration here. The block 1332 depicts displaying particular set of coupon offerings that are premium in comparison to the other coupon offerings with coupon offerings having an order in which they are displayed. The flow chart diagram of FIG. 14 provides another example embodiment of a method 1400 according to the inventive subject matter described herein. In this method, block 1402 depicts a coupon dispensing device located in a retail establishment, such as but not limited to the coupon dispensing devices described above. According to this method, the dispensing device displays a selection of coupon offerings on a graphical display, as depicted in block 1404, such as those shown in FIG. 4A, 4B or 4C. According to this method, the coupons are for goods or services offered for sale at the retail establishment. As depicted in block 1406, the coupon offerings are displayed in two or more groups 402, 404, 406, wherein one group is displayed at a time. As shown in block 1408, a consumer operates the dispensing device to sequence through displays of groups on the display. For example, sequence from group 402 to group 404 to group 406. As shown in block 1414, the consumer selects one of the coupon offerings to print a coupon. Further, block 1434 depicts using a proximity detector on the dispensing device to detect the presence of a consumer at the device, and block 1436 depicts associating coupons together that were printed while the proximity detector indicated that a person was in continuous proximity to the device so that coupons selected by the same or what appears to be the same person can be determined. In another embodiment, this identification is printed on the face of a coupon in a human and or machine readable format (barcode or otherwise) that could be processed later.

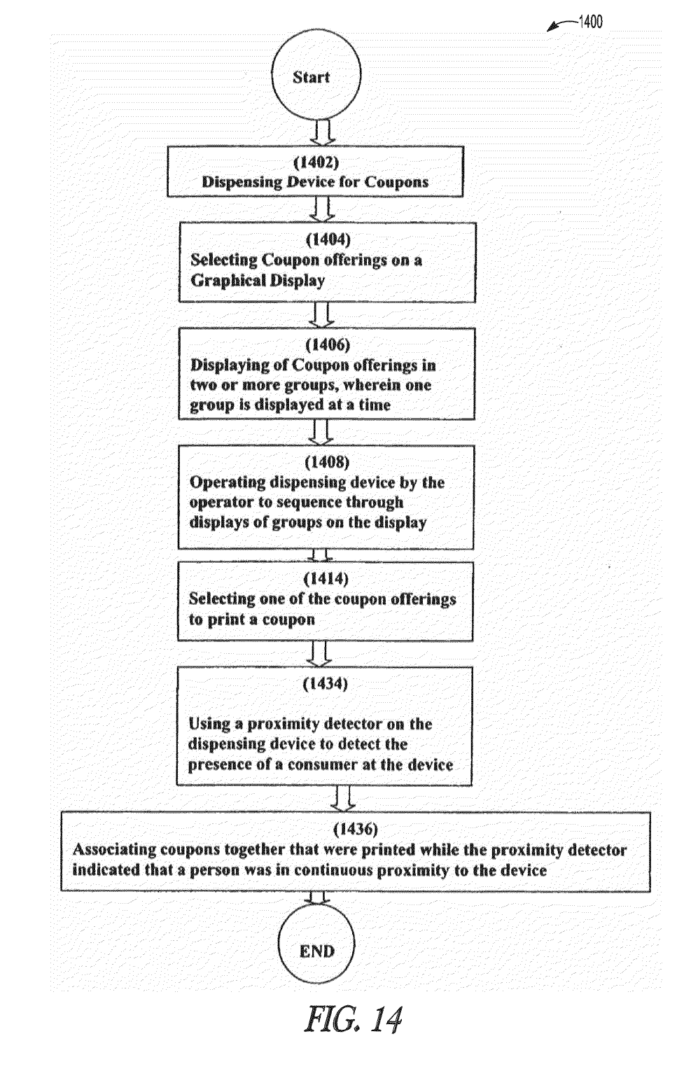

In yet another embodiment 1500 of the inventive matter under consideration here, block 1502 depicts a coupon dispensing device deployed in a retail establishment, block 1504 depicts selecting coupon offerings on a graphical display, block 1506 permits display of coupon offerings in two or more groups 402, 404, 406, wherein one group is displayed at a time. Block 1508 depicts operating the dispensing device by the operator to sequence through displays of groups on the display. For example, sequence from group 402 to group 404 to group 406. Block 1538 in this embodiment, depicts having at least some of the groups of coupon offerings have about 6 to 18 offerings in them and block 1540 depicts permitting a consumer to advance from the display of one group to the next by making one input to the device. In yet another alternate method similar to that of FIG. 15, the number of coupon offerings is about 12, the number of groups is about 3 and further wherein the one input is made by pressing a physical button on the device or a button icon on a touch screen display.

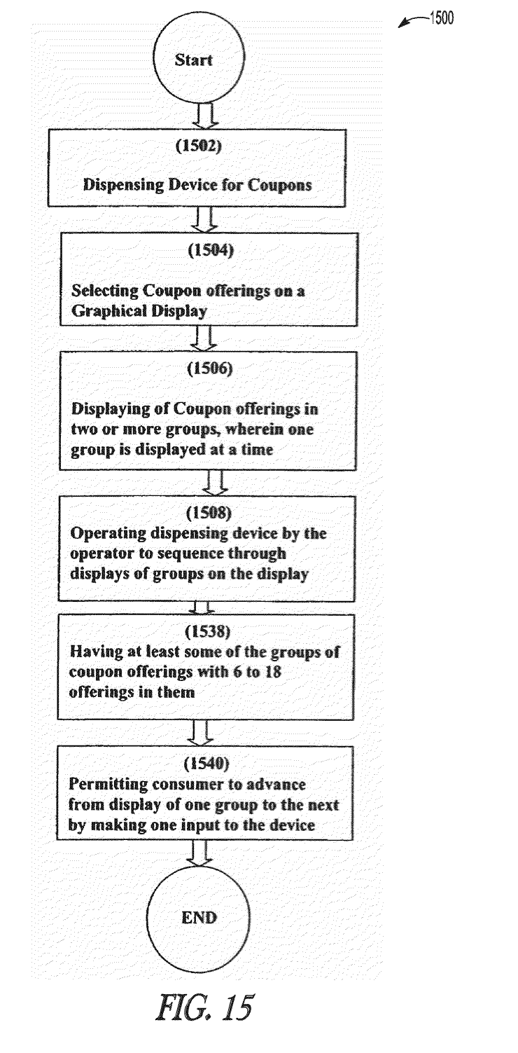

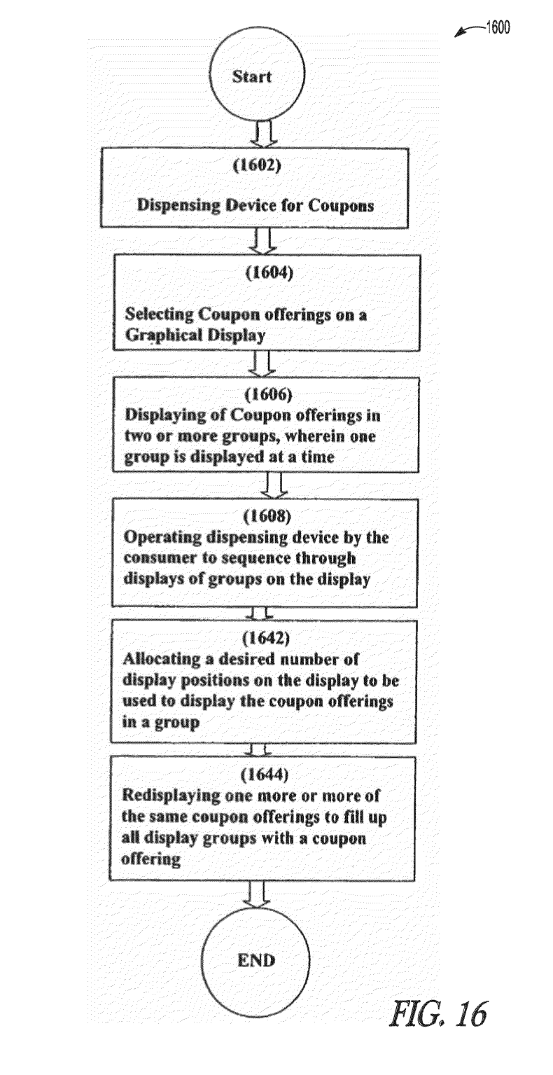

FIG. 16 is flow chart diagram of yet another embodiment 1600 of the inventive matter that is under consideration here. The additional block 1642 depicts here allocating a desired number of display positions on the display to be used to display the coupon offerings in a group. Further, block 1644 depicts redisplaying one more or more of the same coupon offerings previously displayed in a different group, if there are not enough coupon offerings available to display in the total number of display positions available while sequencing through groups of coupon offerings, so that all display groups are filled with a coupon offering. For example, if there were only 30 coupons to display but a total of 36 coupon display areas in three groups, the coupons would be rotated for display. Note that the first six coupons displayed in a first group may be repeated as the last six coupons displayed in a third group.

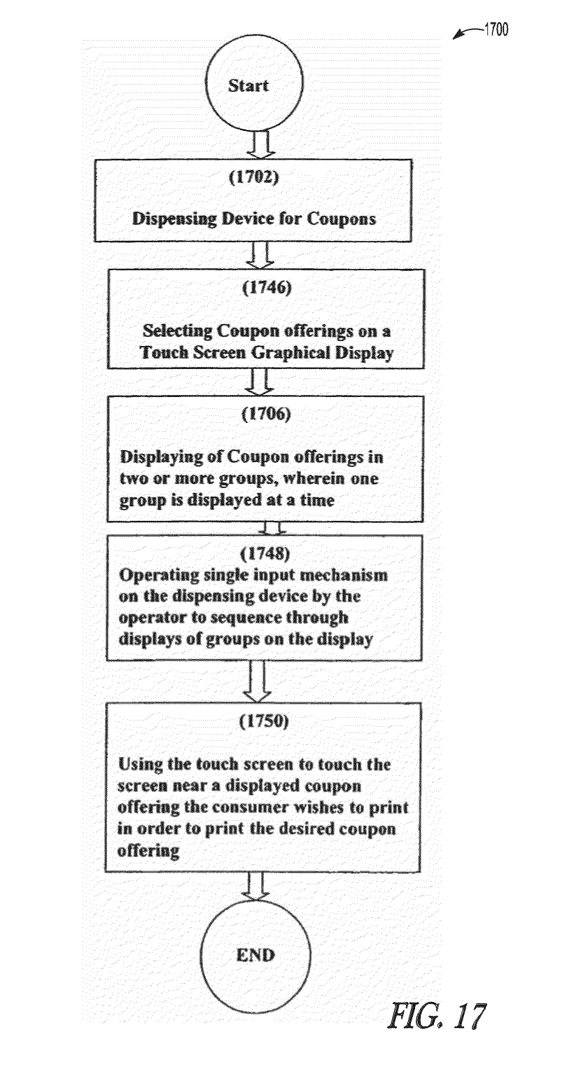

The flow chart diagram of FIG. 17 shows another example embodiment of a method 1700 according to the inventive subject matter described herein. In this method, block 1702 depicts a coupon dispensing device located in a retail establishment, such as but not limited to the coupon dispensing devices described above. According to this method, the dispensing device displays a selection of coupon offerings on a touch screen graphical display, as depicted in block 1746, such as those shown in FIG. 4A, 4B or 4C. According to this method, the coupons are for goods or services offered for sale at the retail establishment. As depicted in block 1706, the coupon offerings are displayed in two or more groups 402, 404, 406, wherein one group is displayed at a time. As shown in block 1748, a consumer operates single input mechanism on the dispensing device to sequence through displays of groups on the display. For example, sequence from group 402 to group 404 to group 406. Further, block 1750 depicts a consumer using the touch screen to touch the screen near a displayed coupon offering the consumer wishes to print in order to print the desired coupon offering.

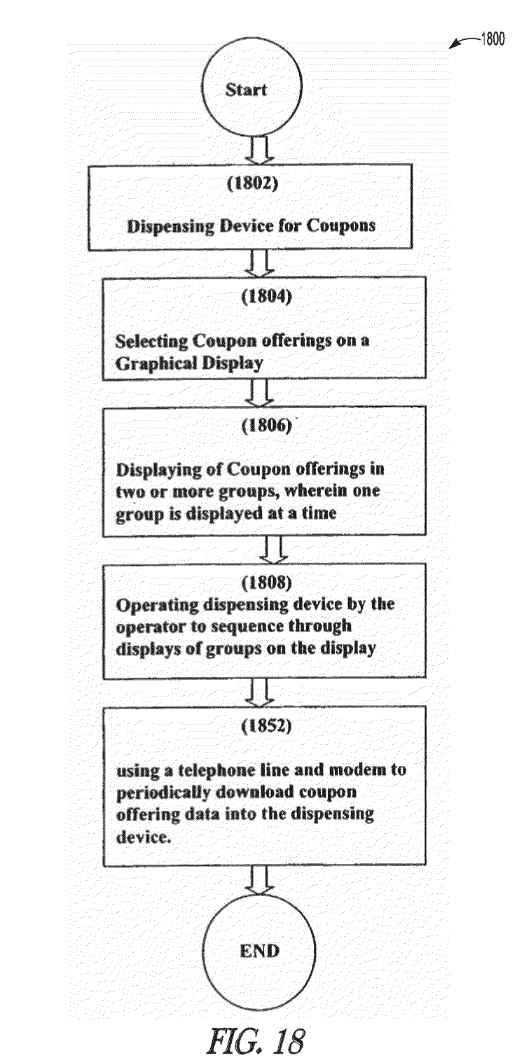

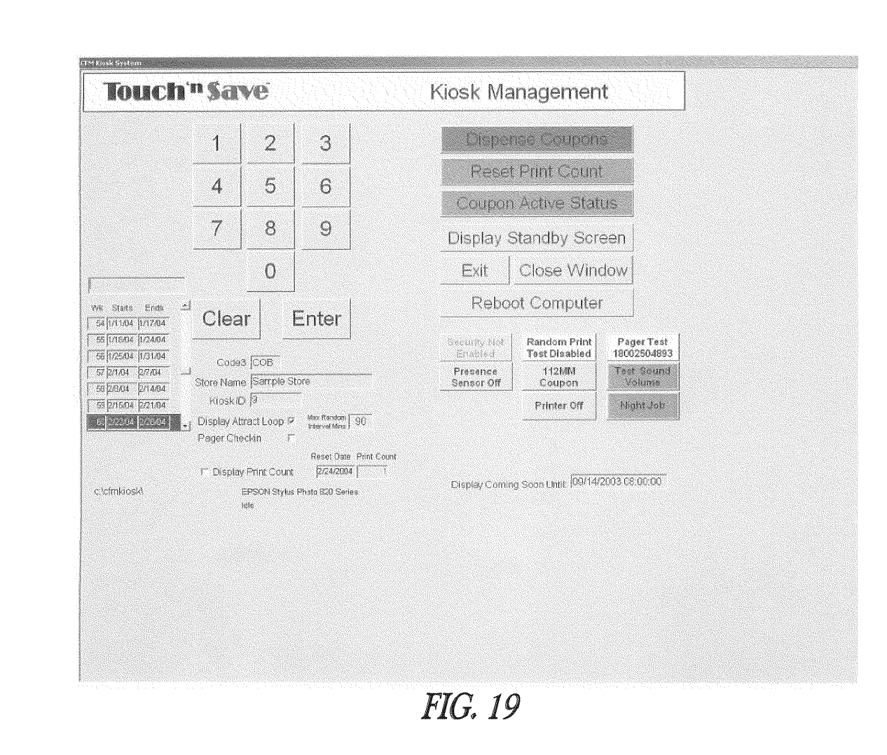

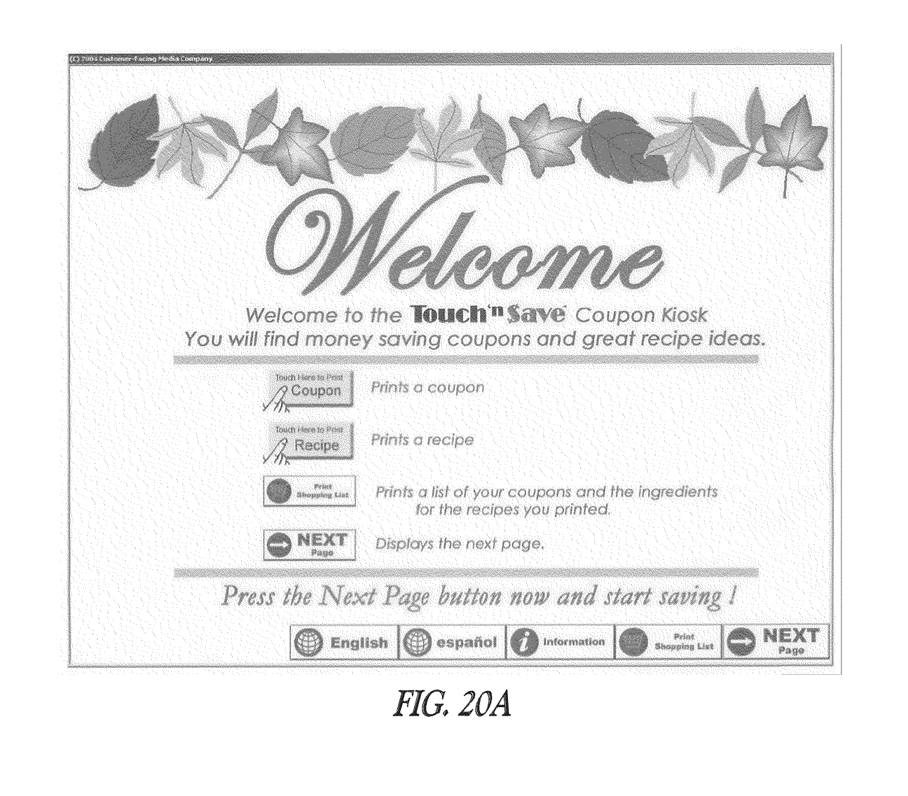

FIG. 18 is flow chart diagram of an alternate embodiment of a method according to the inventive matter under consideration here. In this embodiment, block 1852 depicts using a telephone line and modem to periodically download coupon offering data into the dispensing device illustrated in FIGS. 1A, 1B, 1C. According to yet another alternate embodiment, the various methods above may also include printing a coupon with a bar code that can be read by a bar code reader.

Described above with respect to FIGS. 3 to 18 are a number of alternate embodiments according the inventive subject matter disclosed herein. These methods, in one example embodiment, are implemented in whole or in part as software executable on the processing unit of a dispensing device such as device 102, and data supporting such operation is also stored in a memory or data storage component on a dispensing device, such as device 102.

According to still other example embodiments, the following features may be provided:

```
Display Ads
    10 page Layouts Supported
    Music/Sound - 1 per page
Manufacturers Coupons
    Expiration date: enter date or days future
    Consumer/Retailer small print for each manufacturer
In Store Coupons
    Expiration date: enter date
    Consumer/Retailer small print for store chain
Display Ad while printing
    Advertising opportunity for up to four advertisers
    Includes music/sound
Ad Rotation
    Ad rotation replaces attract loop - possible with display sized ads
    Pages advance when no one is present
    Turn off presence sensor on Kiosk Management screen to bypass for
    demo
Other Features:
    Companion Coupon
    Dynamic Coupon
    Additional Information
        Recipe
        Nutrition information
```

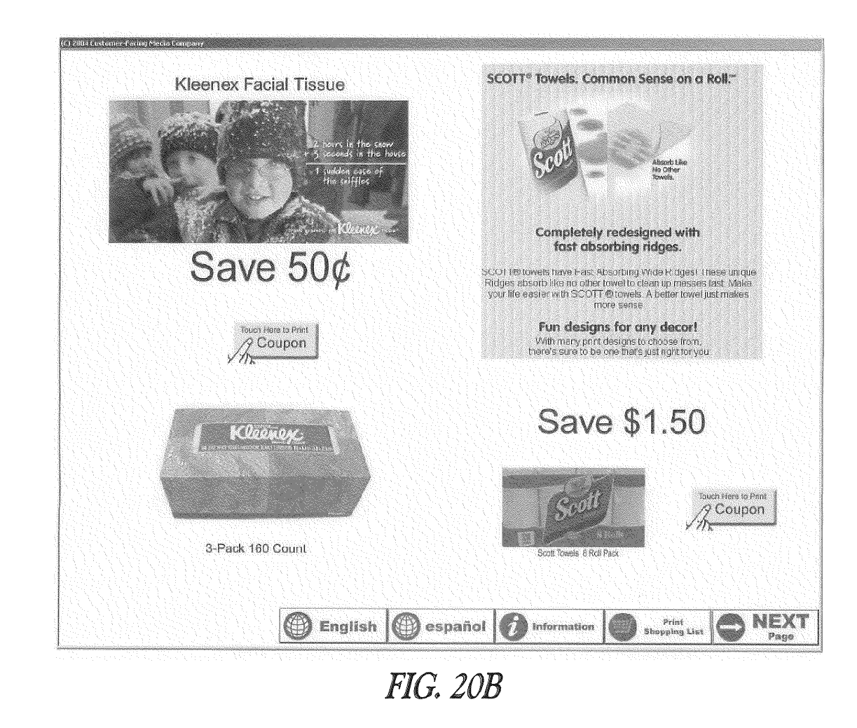

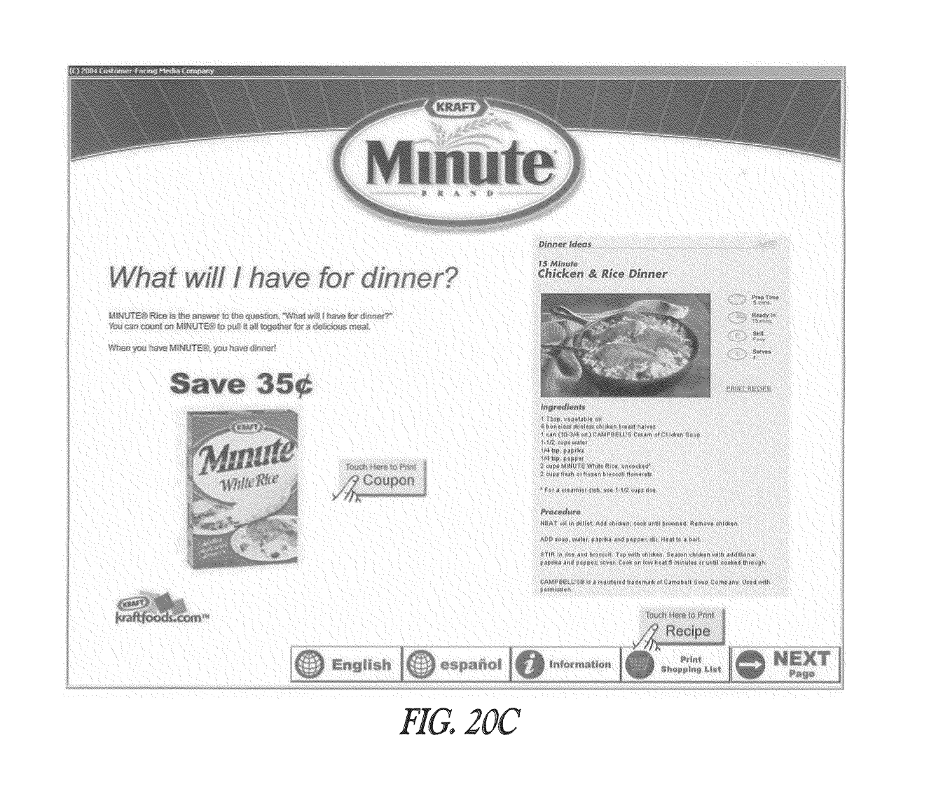

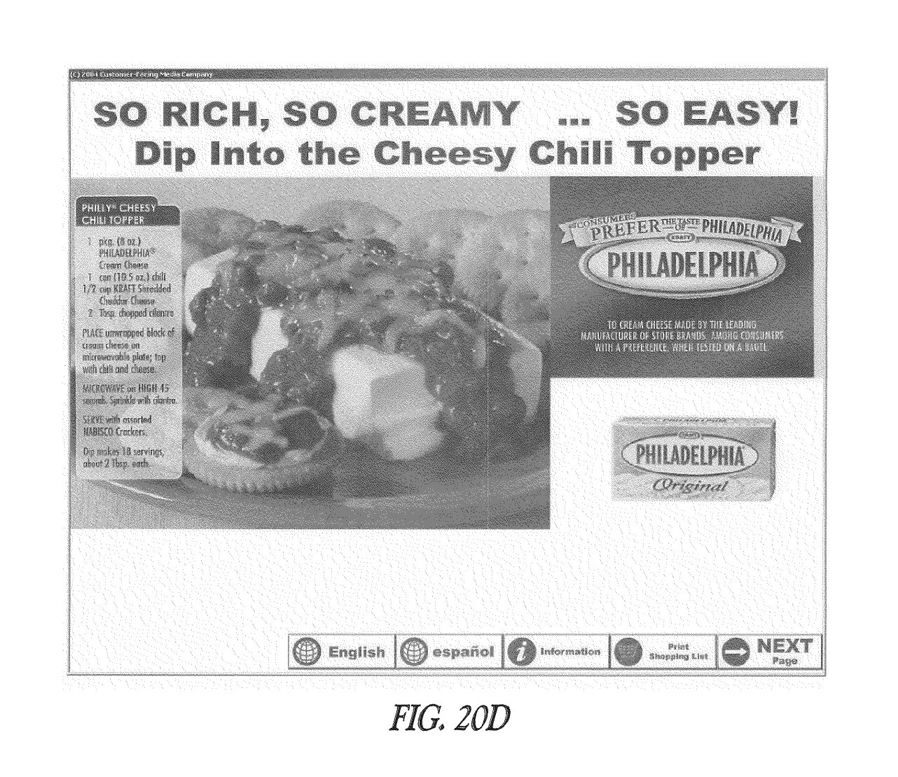

Referring to FIGS. 20A, 20B, 20C and 20D, there is shown an alternate embodiment of screen displays for touch screen operation. The initial page shown on 20A may provide instructions for use of the system, offering the user a chance to press a NEXT Page button to view one or more successive screens showing coupon offerings, as shown in FIGS. 20B, 20C and 20D. Each screen offers a chance to print a coupon for one or more different product offerings, or offers to print a coupon for use of a product offering, along with a button for a coupon, as shown in FIG. 20C.

Referring to FIG. 21, there is shown a perspective view of a coupon dispensing kiosk or station 2100, which includes a first screen 2102 that may be used to display coupon offering touch screens, and a screen 2104 (which may be referred to a as a “marquee display”) that may be used to display advertisements, either billboard style or videos, continuously or on-demand, for example in response to a customer approaching the station 2100 as may be detected by a proximity detector supported by the housing. A printer is also located in station 2100 to print coupons or recipes or other printed materials. According to another embodiment of the system and method according to the inventive subject matter, the advertising screen 2104 displays an advertisement that corresponds to or is associated with a recipe or coupon that is selected. Alternatively, the display 2104 may be used to advertise a product or service that no coupon is offered for.

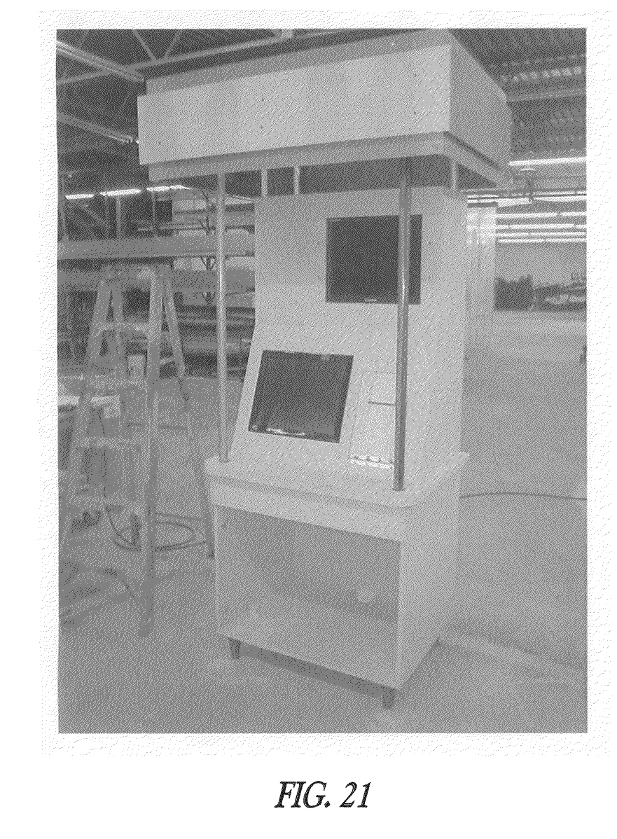

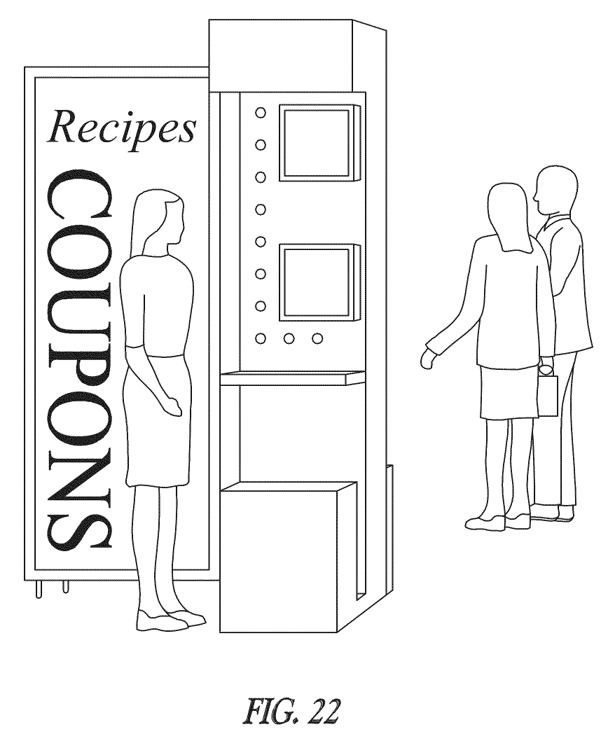

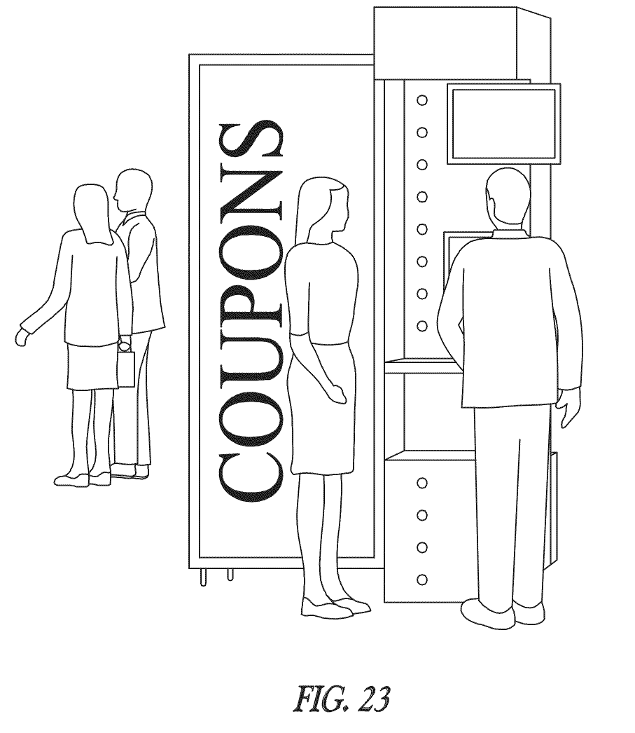

Referring to FIGS. 22 and 23, there are shown alternate embodiments of a coupon dispensing stations 2200 or 2300.

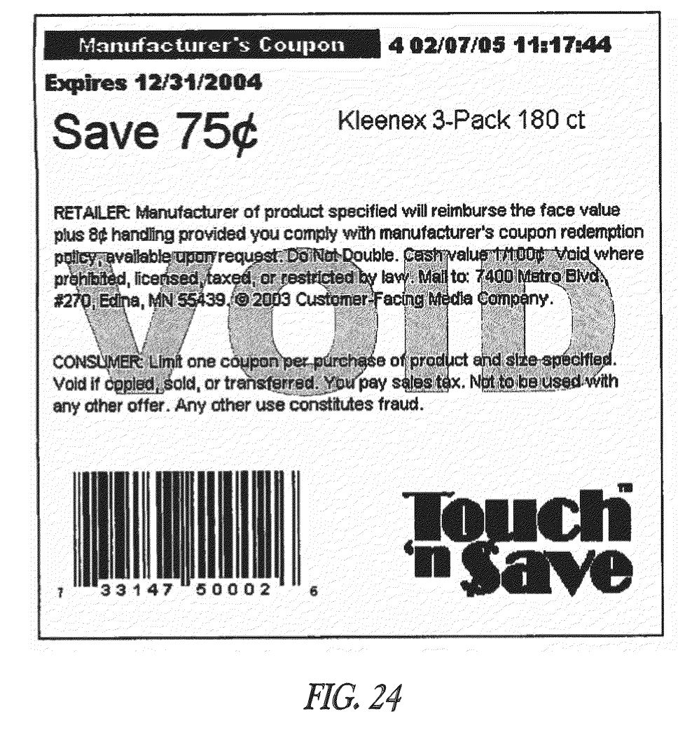

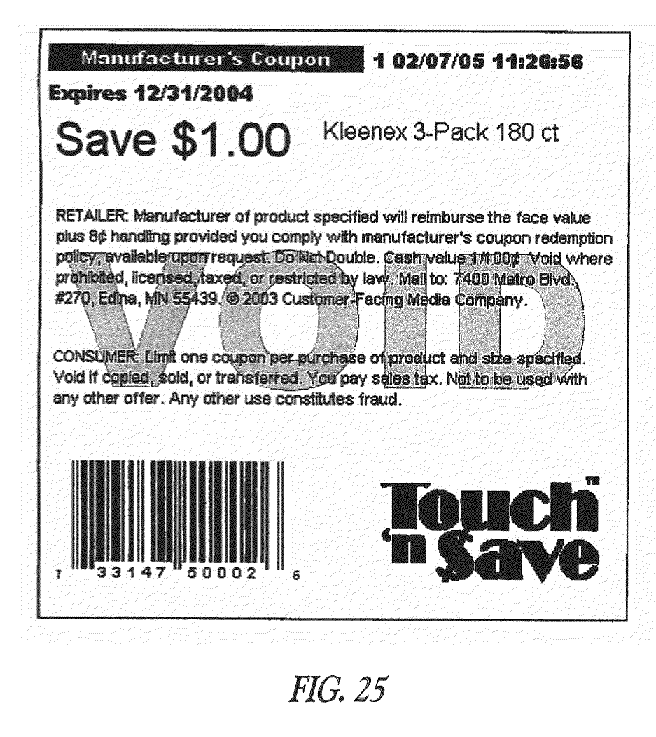

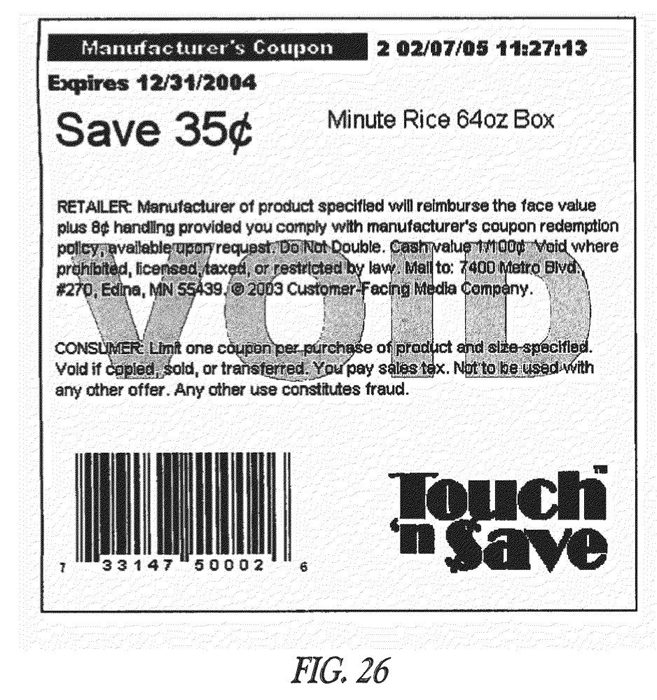

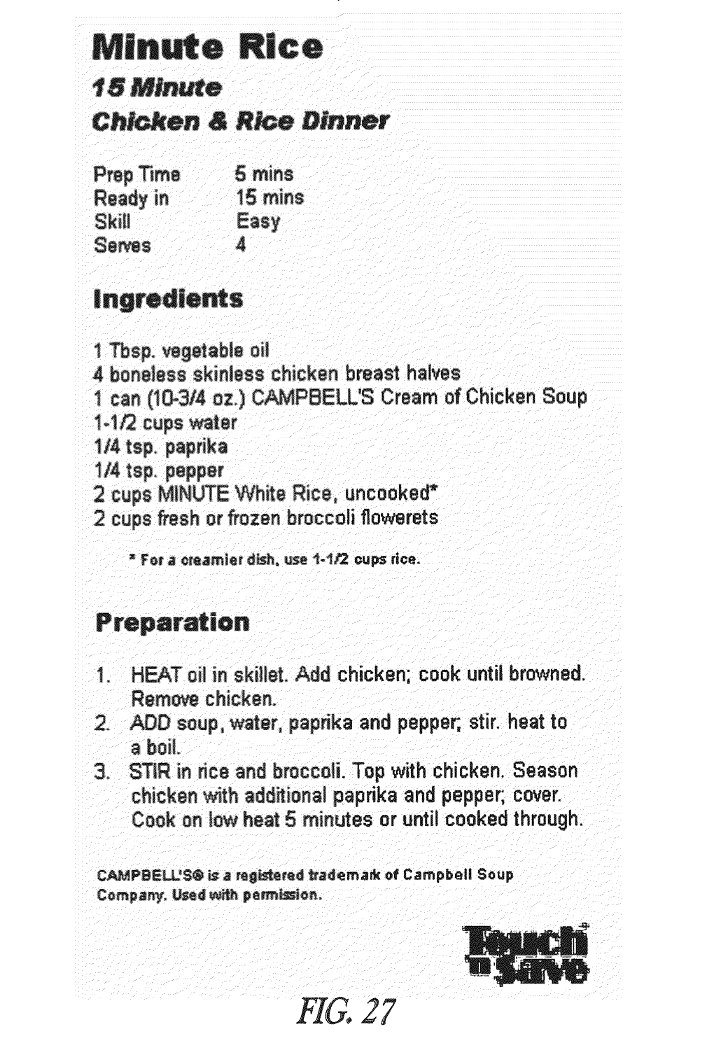

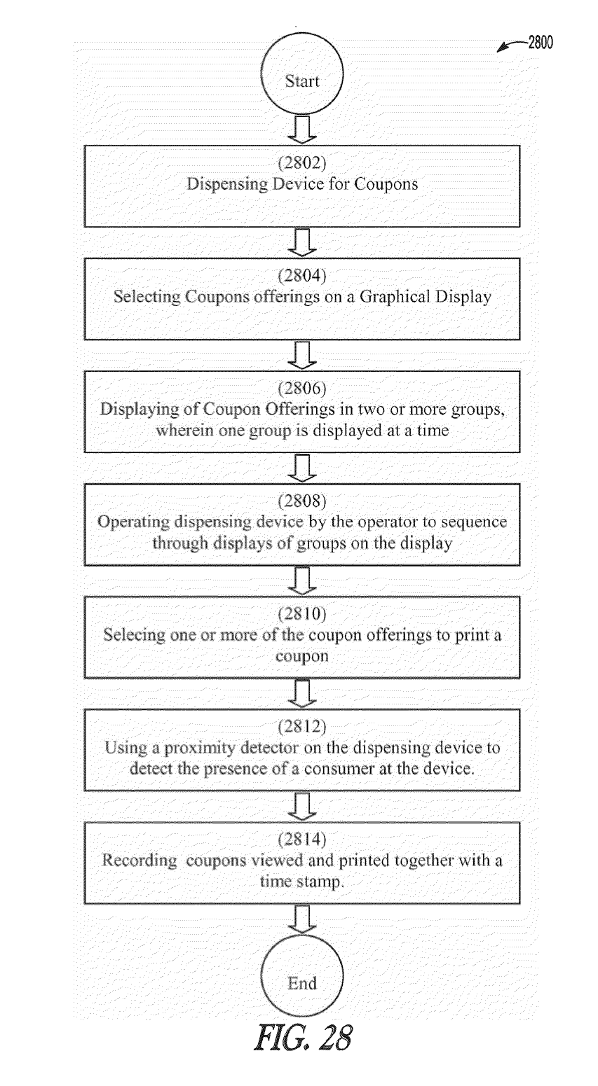

Referring to FIGS. 24, 25, 26 and 27, there are shown example embodiments of coupons or recipes 2400, 2500, 2600 and 2700, that may be printed for example in response to selection of a print coupon button on a touch screen.

According to another alternate embodiment, full page ads for a single product only may be displayed on each touch screen display.

According to still another example embodiment, the system and method of the inventive subject matter provides software adapted to execute on a coupon dispensing computer to prepare a shopping list, or simply print a stored shopping list to accompany a recipe offered on the system.

According to still another example embodiment, a navigation bar may be displayed on the touch screen displays of any of the illustrated embodiments to allow a user to jump to a desired offer for a coupon or recipe or other offering.

According to another example embodiment, touch screen coupon offerings may rotate when no one is in front the kiosk.

Thus, there have been described a number of example embodiments of the inventive subject matter.

### Other Examples

Referring now to FIGS. 1B and 1C there is illustrated block diagrams of a coupon dispensing system 100 according to one example embodiment of the inventive subject matter presented herein. FIG. 1B includes a proximity sensor 116, configured to sense a proximity of a consumer. FIG. 1C includes a floor mat 132, a sound shower 134, and a scent generator 130. In certain examples, the floor mat 132 can be used to detect the proximity of a consumer, the sound shower 134 can be used to communicate a sound to the consumer, and the scent generator 130 can be used to communicate a scent to the consumer. In an example, the sound or the scent can be associated with a particular consumer good or product meant to be marketed or otherwise displayed to the consumer.

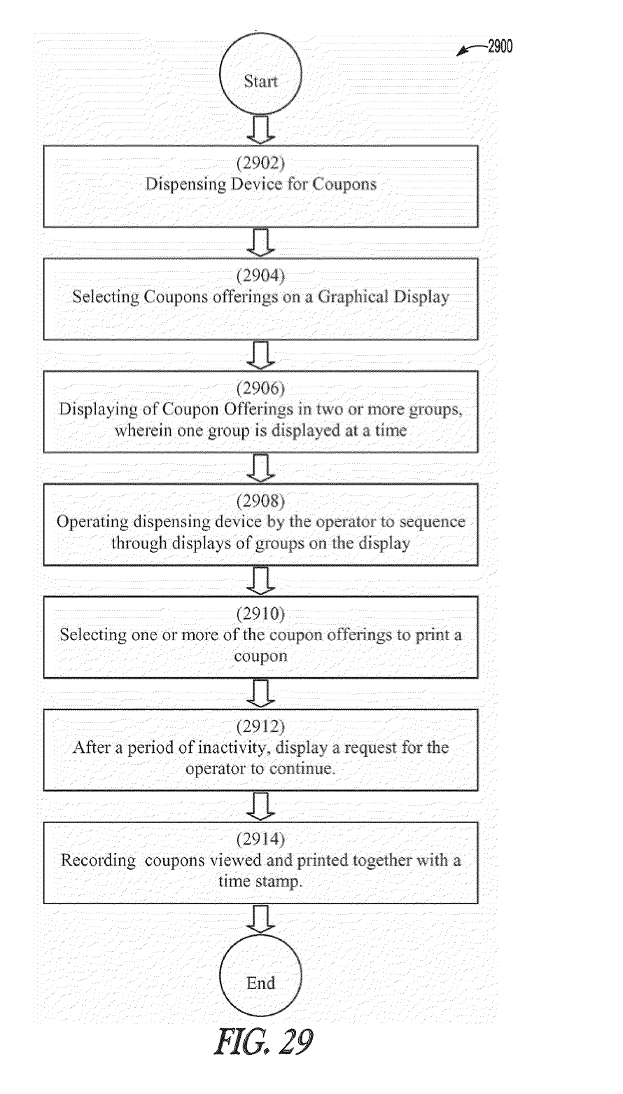

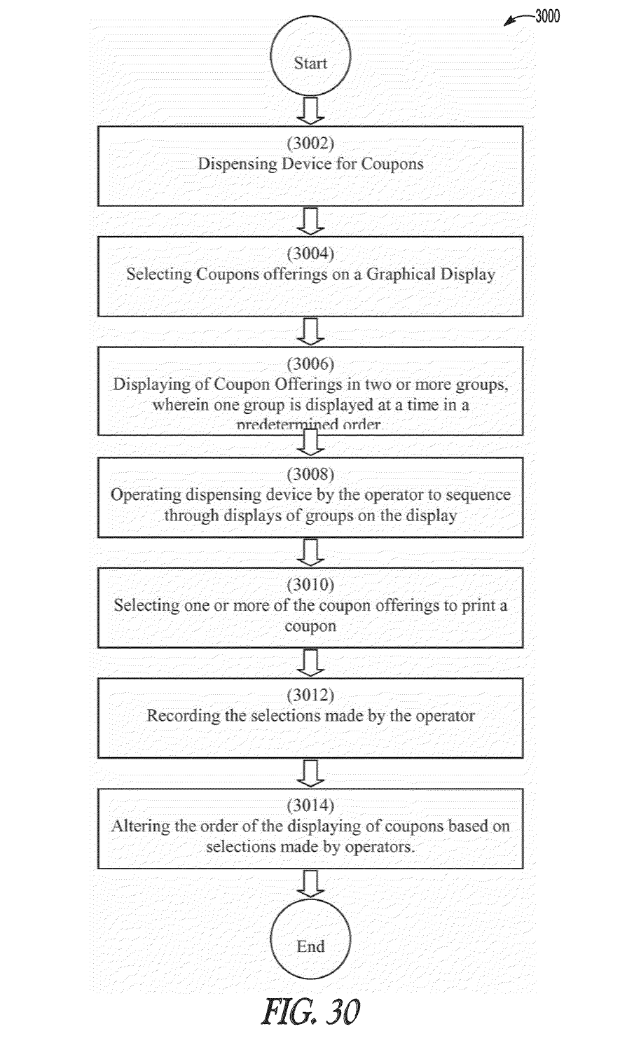

In an example, consumer interactions can be grouped, segmented, recorded, or a combination of at least one of grouped, segmented, or recorded using the touch screen, such as shown in FIGS. 28-29.

The flow chart diagram of FIG. 28 provides another example embodiment of a method 2800 according to the inventive subject matter described herein. In this method, block 2802 depicts a coupon dispensing device located in a retail establishment, such as but not limited to the coupon dispensing devices described above.

According to this method, the dispensing device displays a selection of coupon offerings on a graphical display, as depicted in block 2804, such as those shown in FIGS. 4A, 4B, 4C, or 4O. According to this method, the coupons are for goods or services offered for sale at the retail establishment.

As depicted in block 2806, the coupon offerings are displayed in two or more groups 402, 404, 406, wherein one group is displayed at a time. As shown in block 2808, a consumer operates the dispensing device to sequence through displays of groups on the display. For example, sequence from group 402 to group 404 to group 406. As shown in block 2810, the consumer selects one of the coupon offerings to print a coupon.

Block 2812 depicts using a proximity detector (e.g., proximity sensor 116) on the dispensing device to detect the presence of a consumer at the device, and block 2814 depicts associating consumer interactions with the device together while the proximity detector indicated that a person was in continuous proximity to the device so that coupons selected by the same or what appears to be the same person can be determined. The activity is recorded in the storage device 110 of FIG. 1B.

These recorded interactions would include, but not be limited by the displays viewed, the order of the displays viewed, and which, if any, documents or offers were printed.

In another embodiment, this identification is printed on the face of a coupon in a human and or machine readable format (barcode or otherwise) that could be processed later.

The flow chart diagram of FIG. 29 provides another example embodiment of a method 2900 according to the inventive subject matter described herein. In this method, block 2902 depicts a coupon dispensing device located in a retail establishment, such as but not limited to the coupon dispensing devices described above.

According to this method, the dispensing device displays a selection of coupon offerings on a graphical display, as depicted in block 2904, such as those shown in FIGS. 4A, 4B, 4C, or 4O. According to this method, the coupons are for goods or services offered for sale at the retail establishment.

As depicted in block 2806, the coupon offerings are displayed in two or more groups 402, 404, 406, wherein one group is displayed at a time.

As shown in block 2908, a consumer operates the dispensing device to sequence through displays of groups on the display. For example, sequence from group 402 to group 404 to group 406.

As shown in block 2910, the consumer selects one of the coupon offerings to print a coupon. These recorded interactions would include, but not be limited by the displays viewed, the order of the displays viewed, and which, if any, offers were printed.

Further, block 2912 depicts using an algorithm on the dispensing device to elicit a response from a consumer at the device after a pre-determined period of inactivity.

Block 2914 depicts associating coupons together that were printed within a predetermined period of activity so that coupons selected by the same or what appears to be the same person can be determined. The activity is recorded in the storage device 116 of FIG. 1A.

These recorded interactions would include, but not be limited by the displays viewed, the order of the displays viewed, and which, if any, documents or offers were printed.

In another embodiment, this identification is printed on the face of a coupon in a human and or machine readable format (barcode or otherwise) that could be processed later.

In an example, a display of incentives can be sequenced using user interaction, such as shown in FIG. 30.

The flow chart diagram of FIG. 30 shows another example embodiment of a method 3000 according to the inventive subject matter described herein. In this method, block 3002 depicts a coupon dispensing device located in a retail establishment, such as but not limited to the coupon dispensing devices described above.

According to this method, the dispensing device displays a selection of coupon offerings on a touch screen graphical display, as depicted in block 3004, such as those shown in FIGS. 4A, 4B, 4C, or 4O. According to this method, the coupons are for goods or services offered for sale at the retail establishment.

As depicted in block 3006, the coupon offerings are displayed in two or more groups 402, 404, 406, wherein one group is displayed at a time. As shown in block 3008, a consumer operates single input mechanism on the dispensing device to sequence through displays of groups on the display. For example, sequence from group 402 to group 404 to group 406.

Further, block 3010 depicts a consumer using the touch screen or other pointing device to indicate which coupon offering the consumer wishes to print in order to print the desired coupon offering.

In block 3020 the users interactions are recorded and in bock 3030 the display order is altered, if necessary, based on an algorithm of the plurality of all users interactions.

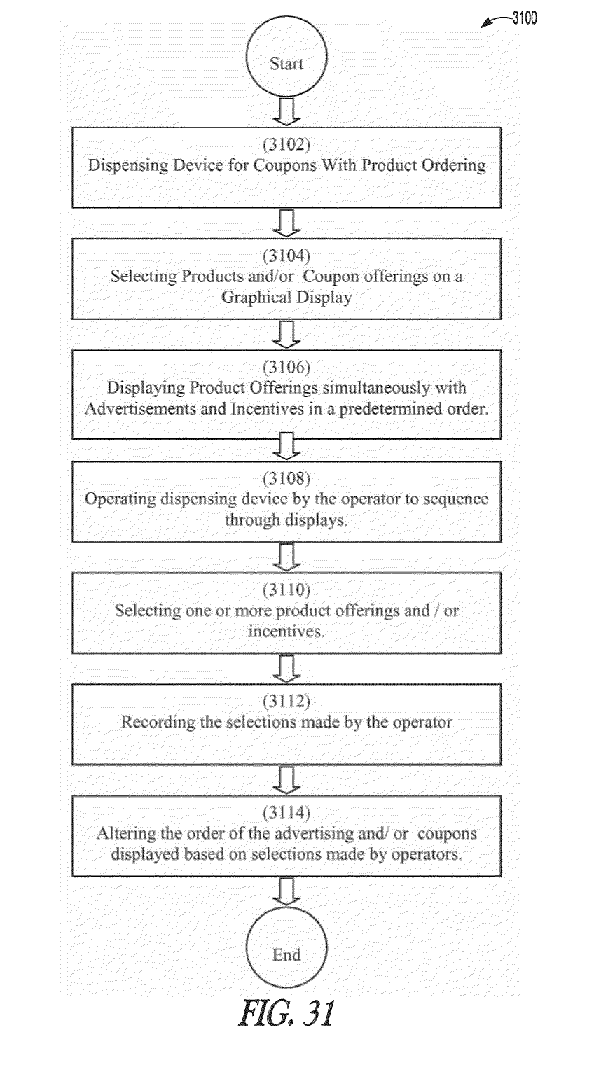

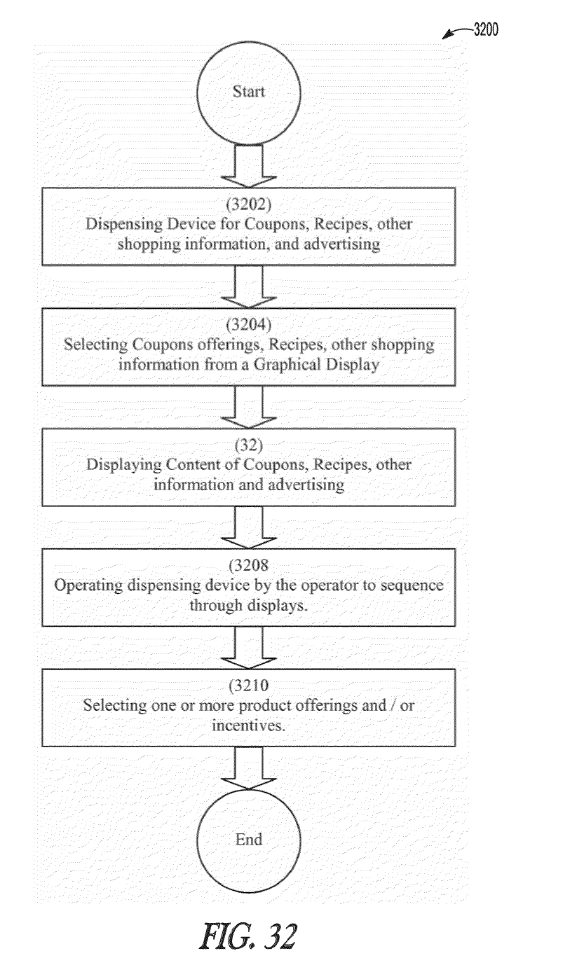

The flow chart diagram of FIG. 31 provides an example embodiment of a method 3100 according to the inventive subject matter described herein. In this method, block 3102 depicts a dispensing device located in a retail establishment, such as but not limited to the coupon dispensing devices described above.

According to this method, the dispensing device displays a selection of product offerings and advertising on a graphical display, as depicted in block 3104, such as those shown in.

According to this method, the product offerings and coupons or other incentives are for goods or services offered for sale at the retail establishment.

As depicted in block 3106, the product offerings are displayed simultaneously with advertising which may include coupons or other incentives. The order of the advertisements and coupons presented is determined by an algorithm which analyzes the users interaction with the program, such as described in FIG. 30.

As shown in block 3108, a consumer operates the dispensing device to sequence through displays. As shown in block 3110, the consumer selects one of the product offerings or chooses to print a coupon or other incentive.

In block 3112 the consumer's interactions with the system (items selected for purchase and coupons/incentives printed) are recorded and in block 3114 the sequence of the advertising displayed is altered.

In an example, consumer content can be displayed with advertising. The advertising can include incentives, and at least one of the advertising or the consumer content can be displayed on a machine, such as disclosed herein. In certain examples, the machine can be displayed in a retail store, and the retail store can be associated with the consumer content and the advertising.

The flow chart diagram of FIG. 32 provides another example embodiment of a method 3200 according to the inventive subject matter described herein. In this method, block 3202 depicts a dispensing device located in a retail establishment, such as but not limited to the coupon dispensing devices described above.

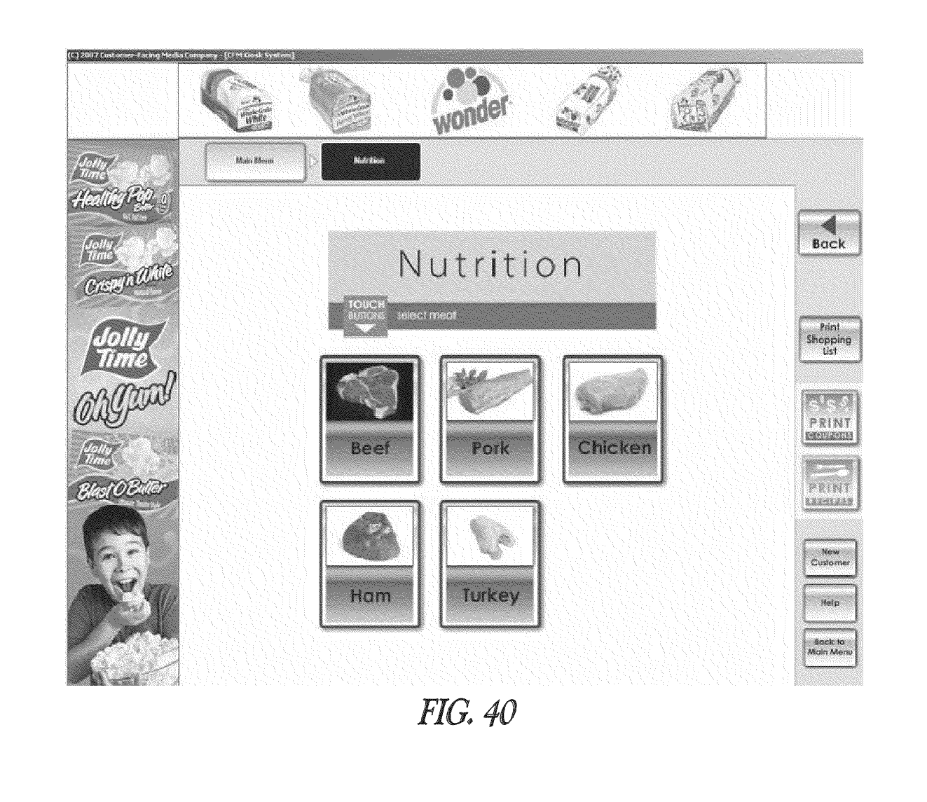

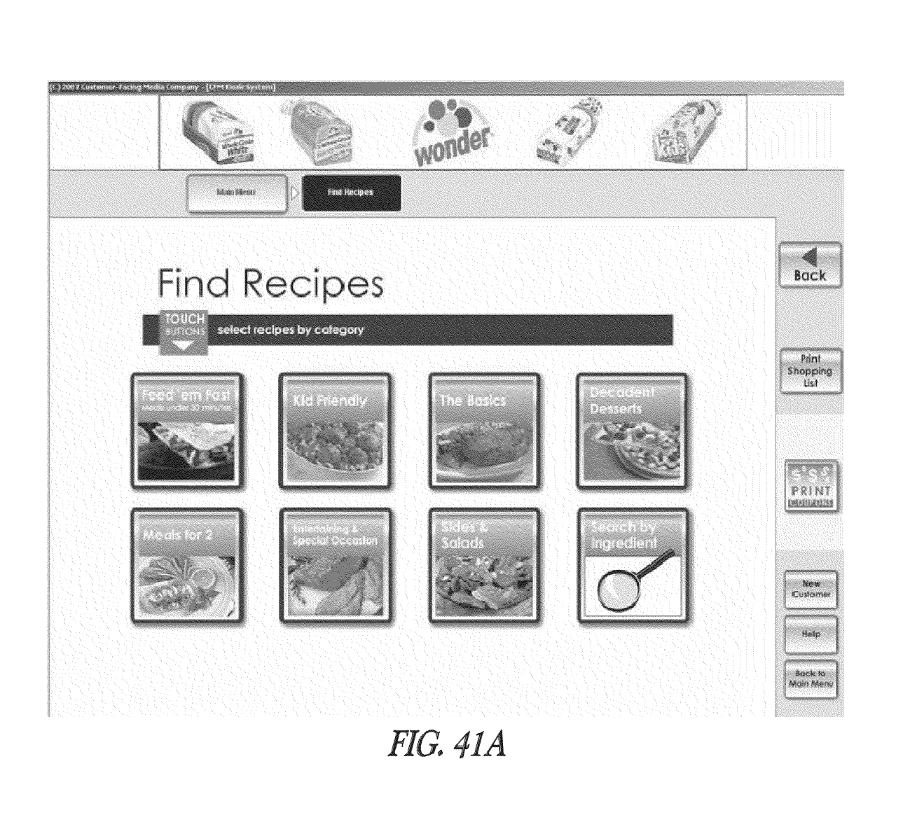

According to this method, the dispensing device displays on a graphical display, a plurality of coupon offerings and/or other type of incentive offering, how-to instructions for use of a product, including but not limited to recipes, and other product information helpful to a consumer making a purchase decision in a retail establishment, as depicted in block 3204, such as those shown in FIGS. 40, 41A, 41B, 41C, 41D, 41E, 42A, 42B, 42C.

According to this method, the coupons and/or other incentive offerings, how-to instructions and/or recipes, and product information are for goods or services offered for sale at the retail establishment.

As depicted in block 3208, a consumer operates the dispensing device to sequence through various displays in a unique sequence determined by the consumer. Such selection may be done with a touch screen or pointing device by pointing to the coupon/incentive offerings and/or how-to instruction/recipe, or by other selecting operation, including but not limited to navigational icons.

As shown in block 3210, the consumer selects one of the coupon/incentive offerings and/or one of the how-to instructions/recipes to print.

In an example, the advertising can include dynamic advertising, such as dynamic incentives or coupons. In this example, one advertisement or offer can be turned off and another advertisement or offer can be turned on using an algorithm, such as a predetermined algorithm. In an example, one offer could be substituted for another based on the number of times an advertisement has been displayed or printed over a time of day, a day of the week, or a combination of the time of day and day of the week.

In an example, consumer interest can be measured, such as by using the system disclosed herein. In this example, a consumer can be asked research questions based on their interaction with the system.

According to still other example embodiments of the methods described above, the following features may be provided:

(1) A method further including in combination with other methods, use of parameters in a database program to determine which research question(s) is displayed in association with at least one coupon or type of incentive offering, and/or at least one how-to instructions/recipe, and/or product information article on a particular device in a particular retail establishment.

(2) A method further including in combination with other methods, the use of parameters in a database program to determine which research question(s) is displayed in association with at least one coupon or type of incentive offering, and/or at least one how-to instructions/recipe, and/or product information article at a particular time of day.

(3) A method further including in combination with other methods, the use of parameters in a database program to determine which research question(s) is displayed in association with at least one coupon or type of incentive offering, and/or at least one how-to instructions/recipe, and/or product information article on a particular day of the week.

(4) A method further including in combination with other methods, the use of parameters in a database program to determine which research question(s) is displayed in association with at least one coupon or type of incentive offering, and/or at least one how-to instructions/recipe, and/or product information article based on the number of times a research question has been displayed.

(5) A method further including in combination with other methods, the use of parameters in a database program to display at least one unique coupon or type of incentive offering to consumers for responding to at least one market research question.

In an example, a shopping list can be displayed, created, or otherwise modified using the method or system disclosed herein, or the shopping list can be input, sequenced, or otherwise associated with features disclosed herein, such as associating an item on the shopping list with a coupon or a product offering for the item.

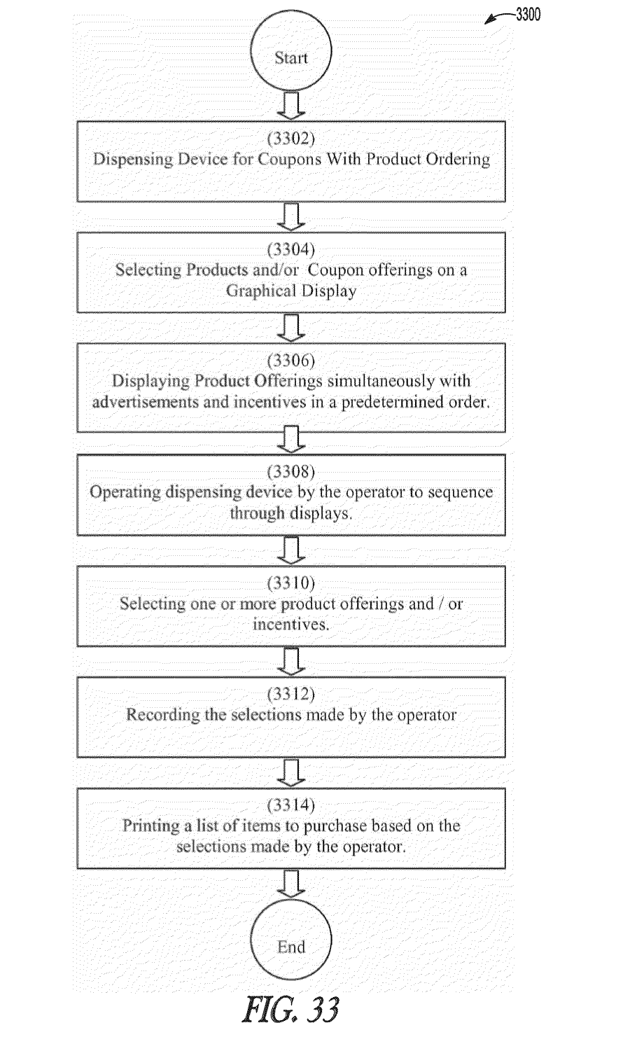

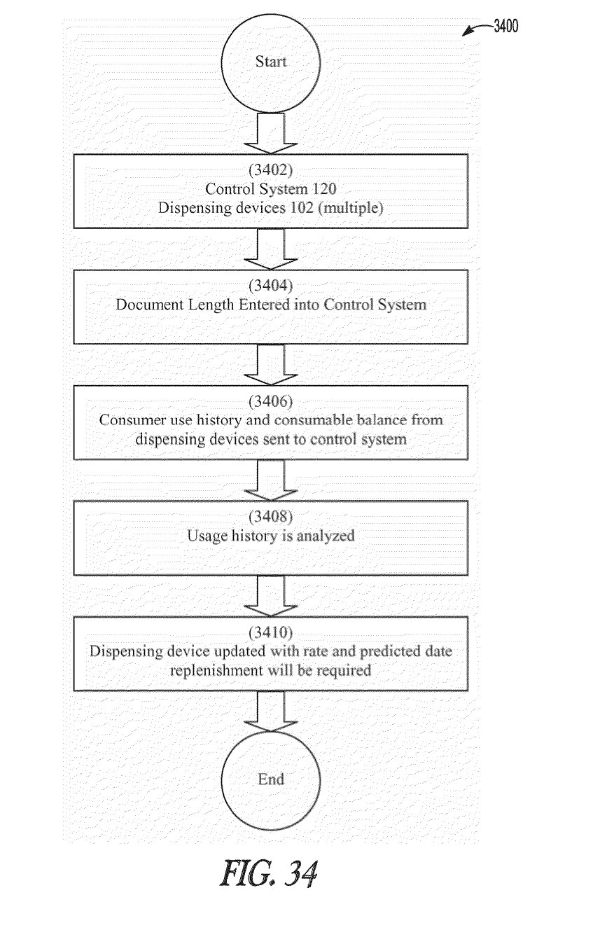

The flow chart diagram of FIG. 33 provides another example embodiment of a method 3300 according to the inventive subject matter described herein.

In this method, block 3302 depicts a dispensing device located in a retail establishment, such as but not limited to the coupon dispensing devices described above.

According to this method, the dispensing device displays a selection of coupon offerings on a graphical display, as depicted in block 3304, such as those shown in FIGS. 40, 41A, 41B, 41C, 41D, 41E, 42A, 42B, 42C. According to this method, the coupons are for goods or services offered for sale at the retail establishment.

As depicted in block 3306, the coupon offerings are displayed in two or more groups 402, 404, 406, wherein one group is displayed at a time. As shown in block 3308, a consumer operates the dispensing device to sequence through displays of groups on the display. For example, sequence from group 402 to group 404 to group 406. As shown in block 3310, the consumer selects one of the coupon offerings to print a coupon.

Block 3312 The activity is recorded in the storage device 116 of FIG. 1B through a method described above, such as that of FIGS. 28 or 29.

Block 3314 depicts a consumer selecting to print a unique shopping list. According to this method using the information stored in database (for example, Database 116), the unique shopping list includes products associated with any and all of the coupon/incentive offerings selected by this consumer, and/or all products associated with any and all advertisements selected by this consumer, and/or all products necessary to complete any and all of the how-to instructions/recipes selected by this consumer (for example recipe ingredients) along with the item quantity, item location in the retail establishment, and any savings due to the nature of the printed coupon/incentive offering(s) and/or selected advertisements, and an advertisement(s), such as depicted in FIG. 40.

In an example, the status of consumables, such as paper or other consumables, can be monitored.

In a further embodiment an algorithm can be used to predict when the consumables supply will be depleted. This is typically the thermal paper that is used to print documents, but could include other consumables that are needed for devices to operate. An additional example in FIG. 1C would be the consumable that is used for the scent generator.

Block 3404: The amount used of each consumable per transaction is entered into control system 120 (FIG. 1A) using authoring tool 130. One example would be document length.

Block 3406: When the consumable supply is replenished for each dispensing device a record is made and stored in storage device 110 (FIG. 1A). This record is transmitted to control system 130. The consumer use history, such as that shown in FIGS. 28 or 29 (e.g., the consumer use history recorded in block 2814 (FIG. 28) or 2914 (FIG. 29)), is transmitted to the control system.

Block 3408: An algorithm is then used to determine the rate of consumption for each dispensing device 102 using the transaction history and amount consumed for each transaction.

Another algorithm is then used to determine the balance of the consumable left in the device using the transaction history and amount consumed per transaction.

A further algorithm is used to predict the date and time the consumable supply will be exhausted for each dispensing device 102.

Block 3410: The results are kept in control system 120 and transmitted to each dispensing device. When the consumable supply reaches a predetermined amount based on usage an alert is displayed on the device to notify employees that the consumable supply is running low and will need to be changed.

A method further including in combination with other methods, collect contact information (fax, email, text) from the remote retail location in a database. Use the predicted number of hours left in the consumable supply to automatically notify the remote retail location that the consumable supply needs to be replenished. Examples of methods of notification could be, but not limited to, a fax, email or text message that the consumable supply needs to be replenished.

In an example, the systems or methods disclosed herein can include an immersive environment.

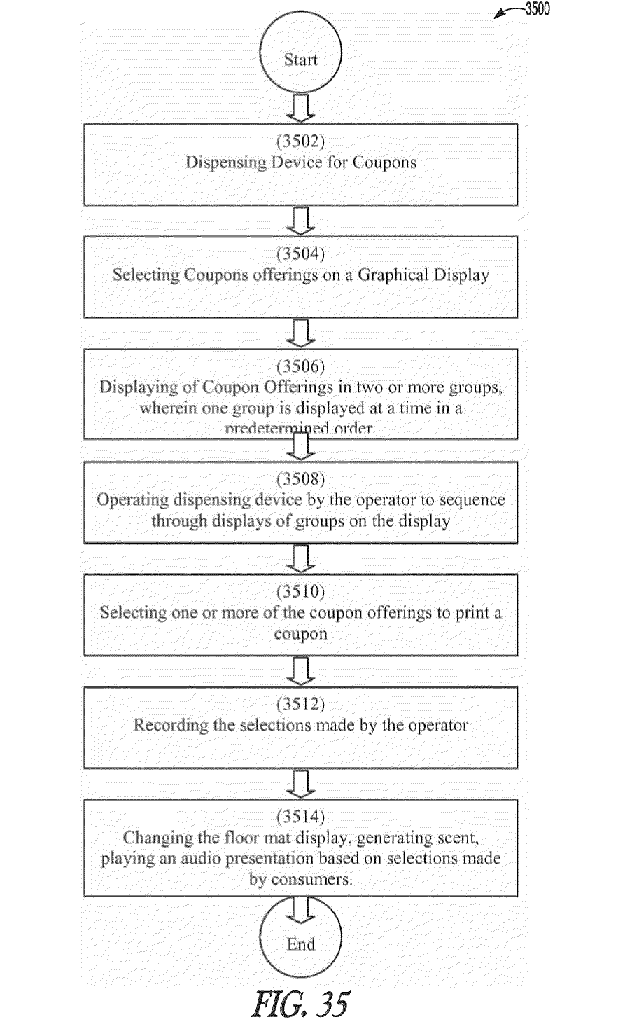

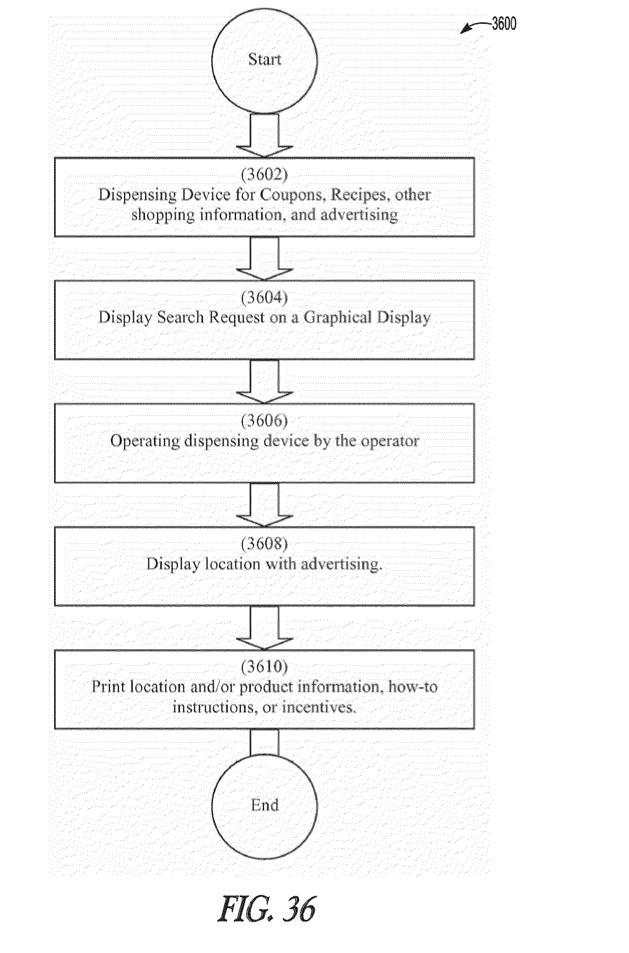

The flow chart diagram of FIG. 35 shows another example embodiment of a method 3500 according to the inventive subject matter described herein. In this method, block 3502 depicts a coupon dispensing device located in a retail establishment, such as but not limited to the coupon dispensing devices described above.

According to this method, the dispensing device displays a selection of coupon offerings on a touch screen graphical display, as depicted in block 3504, such as those shown in FIGS. 4A, 4B, 4C, or 4O. According to this method, the coupons are for goods or services offered for sale at the retail establishment.

As depicted in block 3506, the coupon offerings are displayed in two or more groups 402, 404, 406, wherein one group is displayed at a time. As shown in block 3508, a consumer operates single input mechanism on the dispensing device to sequence through displays of groups on the display. For example, sequence from group 402 to group 404 to group 406.

Further, block 3510 depicts a consumer using the touch screen or other pointing device to indicate which coupon offering the consumer wishes to print in order to print the desired coupon offering.

In block 3520 the users interactions are recorded and in bock 3530 the devices 130, 132 and 134 are controlled based on an algorithm of the plurality of all users interactions.

In an example, the systems or methods disclosed herein can include an item or product locator.

The flow chart diagram of FIG. 36 provides another example embodiment of a method 3600 according to the inventive subject matter described herein. In this method, block 3602 depicts a dispensing device located in a retail establishment, such as but not limited to the coupon dispensing devices described above.

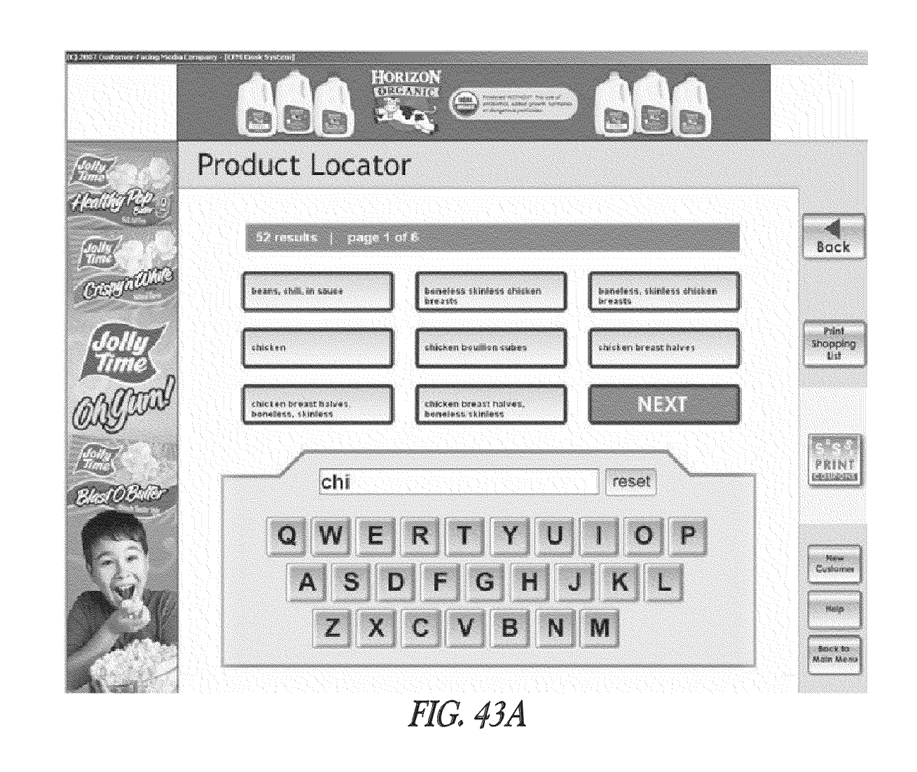

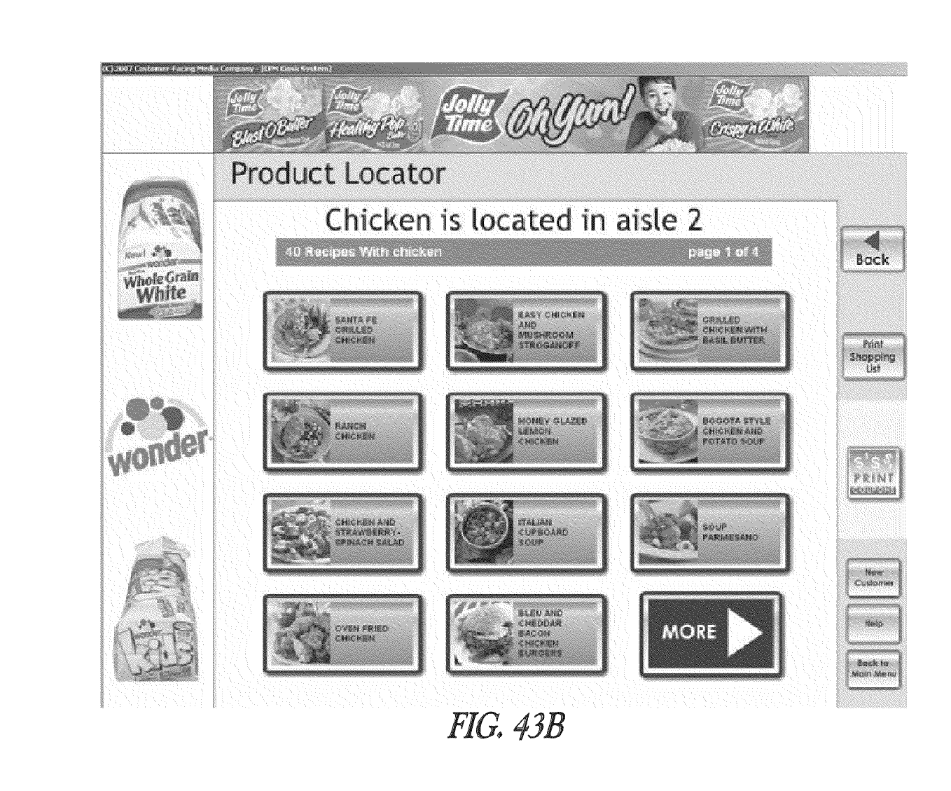

In block 3604 the dispensing device displays on a graphical display an area for the consumer to enter a product name or category. Icons are presented that allow the consumer to enter the product name or category in a number of different ways: pictures of the product, pictures of letters of the alphabet to enter, a display of name of products in a predetermined order as shown in FIG. 43A.

Additionally an advertisement is presented in a predetermined order as defined in FIGS. 28-29.

In block 3606 a consumer makes a selection with a touch screen or pointing device.

In block 3608 the device displays where the product is located in that retail establishment along with advertising displays which may include (not limited to) any of the following: recipes, how to use instructions, purchase incentives as shown in FIG. 43B.

In another example of the method described above the consumer may print out the how-to instruction/recipe or a coupon or other incentive that is displayed (block 3610).

In an example, a content of a system disclosed herein can be searched, and further, the search can include advertising.

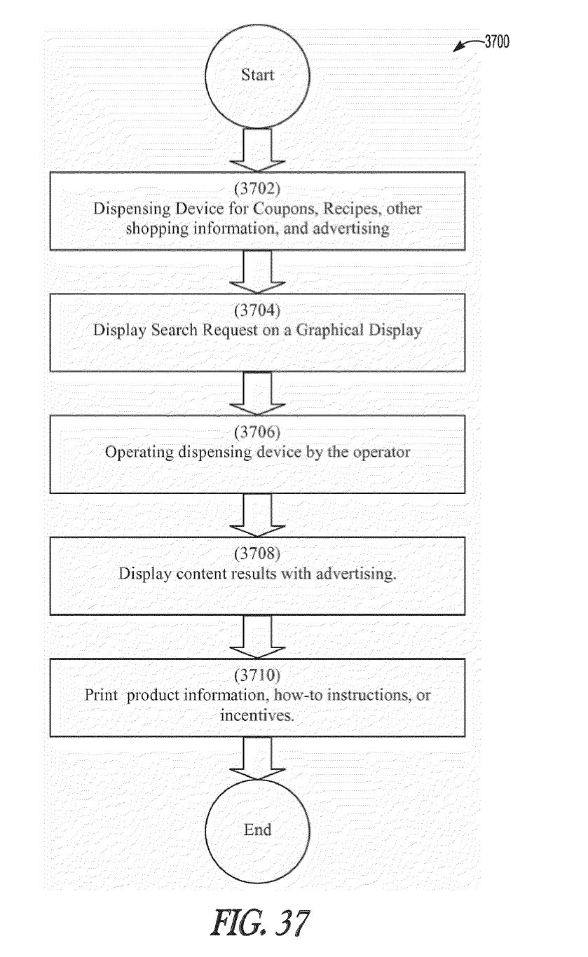

The flow chart diagram of FIG. 37 provides another example embodiment of a method 3700 according to the inventive subject matter described herein. In this method, block 3702 depicts a dispensing device located in a retail establishment, such as but not limited to the coupon dispensing devices described above.

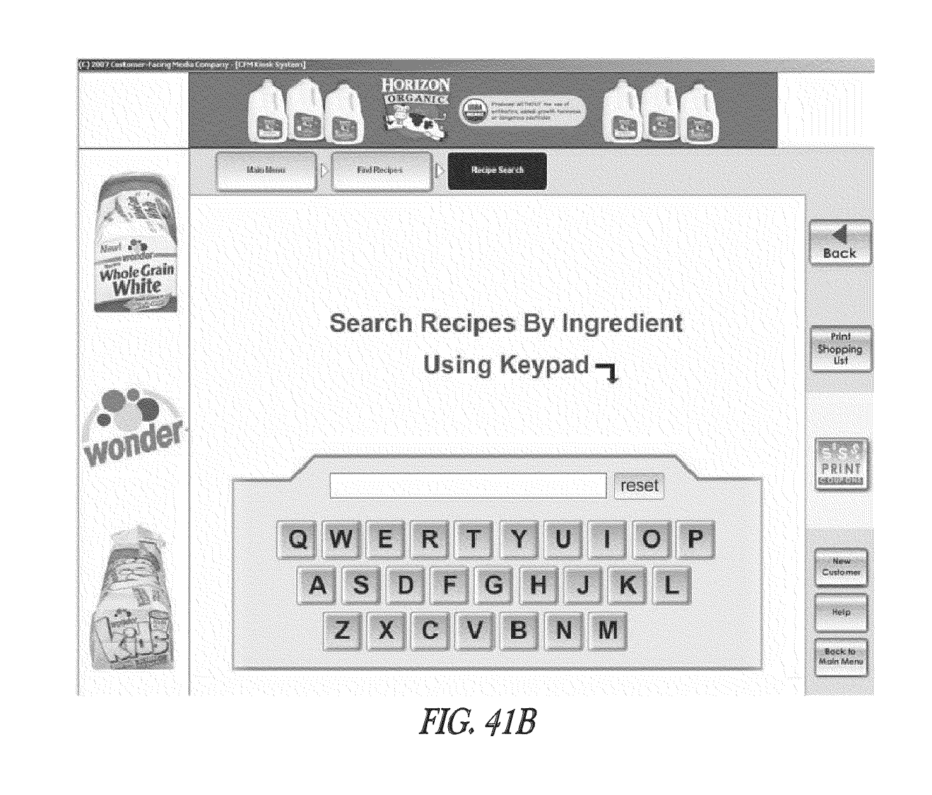

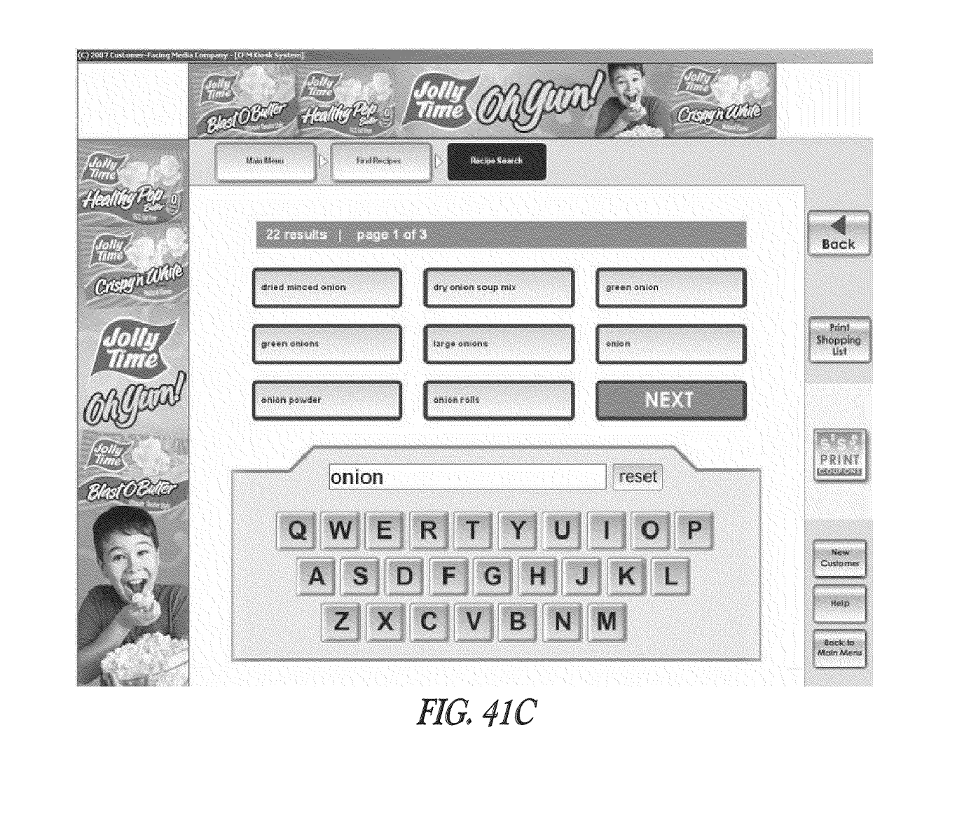

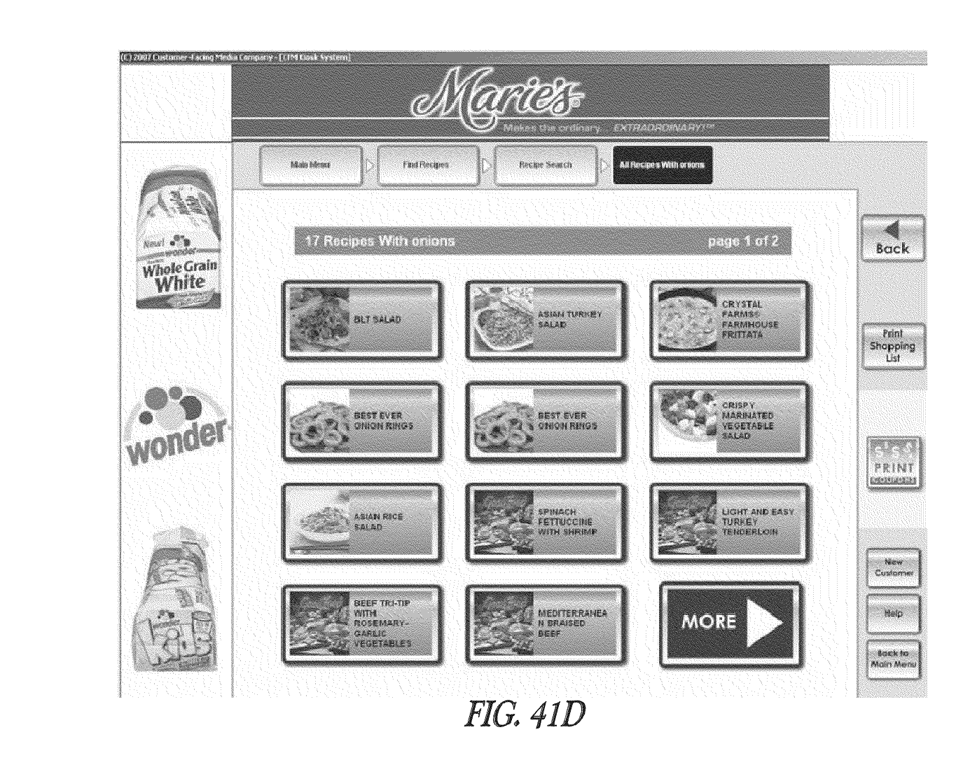

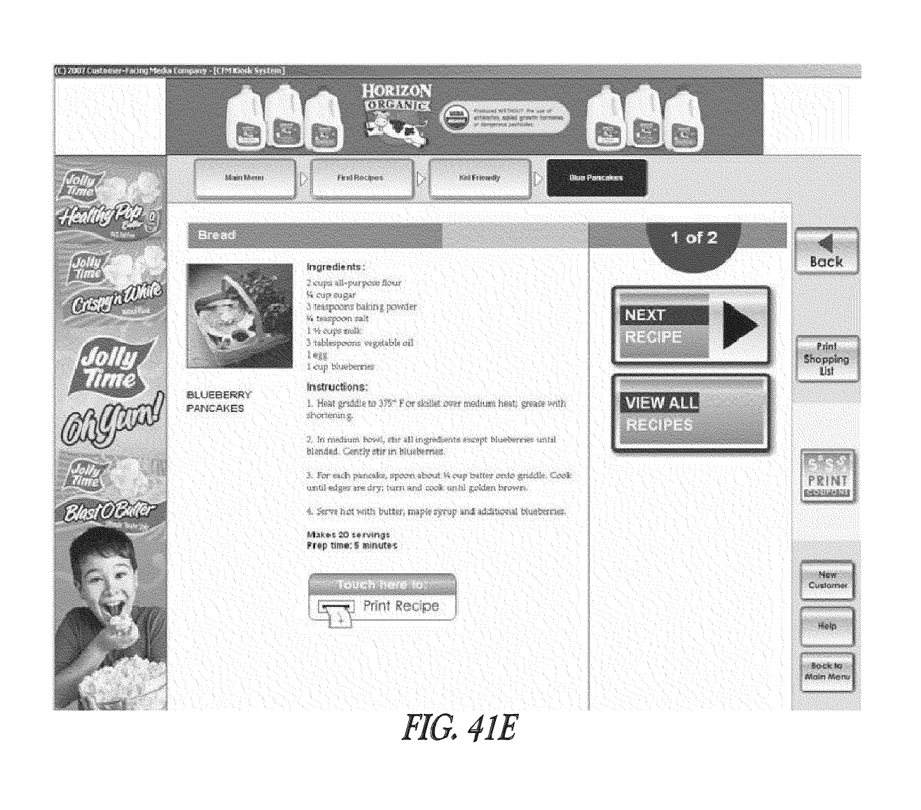

In block 3704 the dispensing device displays on a graphical display an area for the consumer to enter a product name or category, such as shown in FIGS. 41A, 41B, 41C. Such selection may be done with a touch screen or pointing device. Icons are presented that allow the consumer to search the content in a number of different ways: pictures of products or product categories for sale, pictures of letters of the alphabet to enter, a display of name or products in a predetermined order.

As depicted in FIGS. 41A, 41B, and 41C, an advertisement is also displayed on the graphical display area. The order of the advertisement is predetermined. The logic for displaying the advertisement is covered in FIG. 30.

Once the consumer has selected a product or category the device displays the content requested.

In addition to the content the device also displays coupons or other incentives to purchase products for sale by the retailer.

In another example of the method described above the consumer may print out the how-to instruction/recipe or a coupon or other incentive that is displayed.

In an example, the content or layers of the systems disclosed herein can be controlled.

The flow chart diagram of FIG. 37 provides an example embodiment of a method 3700 according to the inventive subject matter described herein.

In this method, block 3702 depicts a dispensing device located in a retail establishment, such as but not limited to the coupon dispensing devices described above. In this method, block 3704 depicts a consumer sequencing through a series of displays to view at least one of the coupon/incentive offerings, and/or at least one of the how-to instructions/recipes, and/or product information articles. Such selection may be done with a touch screen by pointing to the coupon/incentive offerings, and/or how-to instruction/recipe, and/or product information article, or by other selecting operation, including but not limited to navigational icons.

According to this method, block 3706 further includes the use of a database program, the parameters of which determine the placement of one or more advertisements on one or more reserved areas of the display, including but not limited to a method of layering the content to be displayed, and in association with at least one coupon or type of incentive offering, and/or at least one how-to instructions/recipe, and/or product information article accessed by a consumer using the device to sequence through various displays in a unique sequence determined by the consumer.

This method, using parameters in the database, rotates through a pool of ads, such that this method allows for starting the display order independently for each consumer and/or returning to the beginning of the queue when all advertisements have been displayed—without restarting for each consumer.

Further the method, using parameters in the database, interrupts the rotation of advertisements in order to display a specific advertisement from a pool of ads in association with a specific display of at least one how-to instructions/recipe/article and then returns to a rotation through a pool of ads, such that this method allows for starting the display order for each consumer and/or returning to the beginning of the queue when all advertisements have been displayed—without restarting for each consumer.

In this method, block 3708 depicts a consumer selecting to search a pool of at least one how-to instruction/recipe/product information article by at least one consumable item incorporated in the how-to instruction/recipe/product information article.

Further, this method provides the use a database program, the parameters of which determine the placement of one or more advertisements on one or more reserved areas of the display, including but not limited to a method of layering the content to be displayed, and in association with at least one reserved area of the display on which is displayed a graphical interface through which the consumer is able to enter a selected consumable item to be searched.

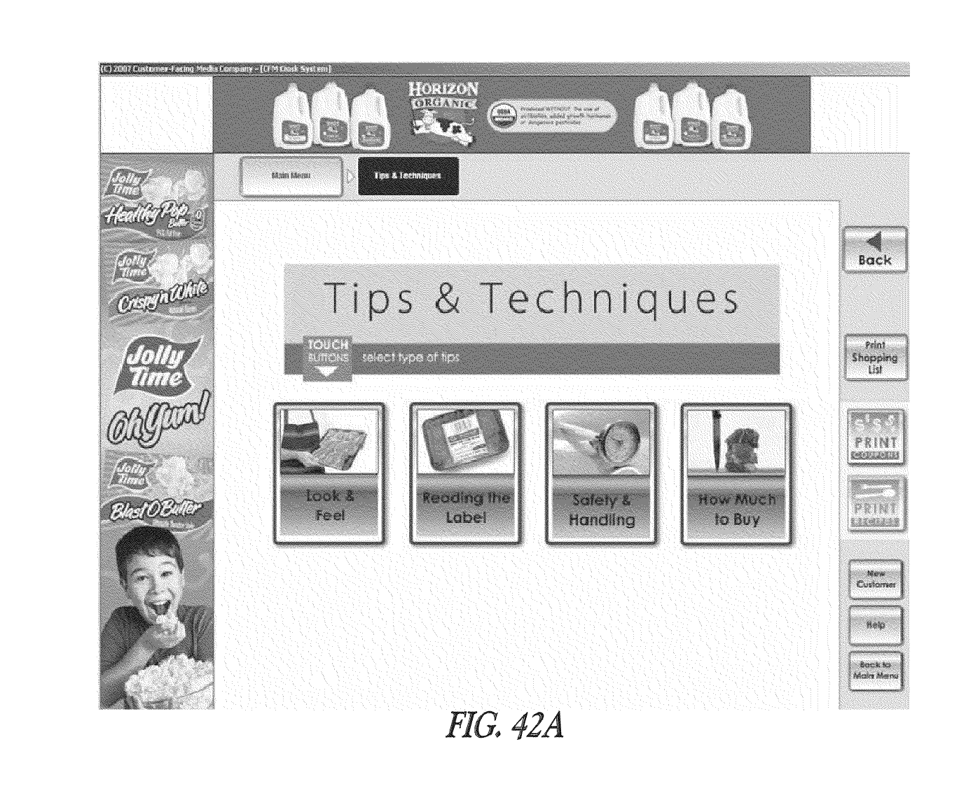

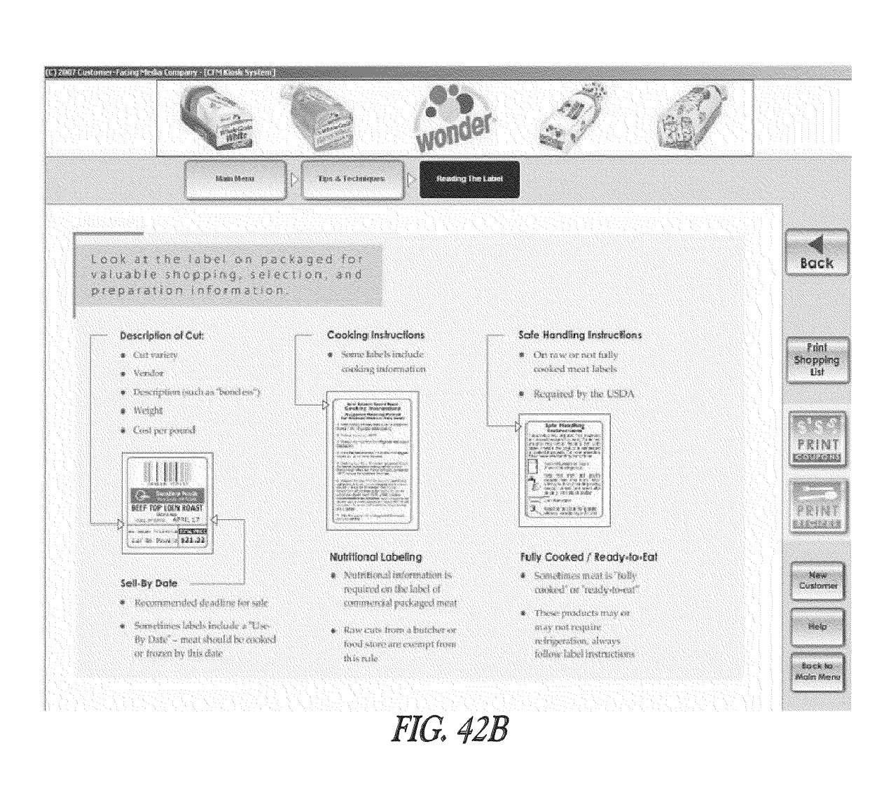

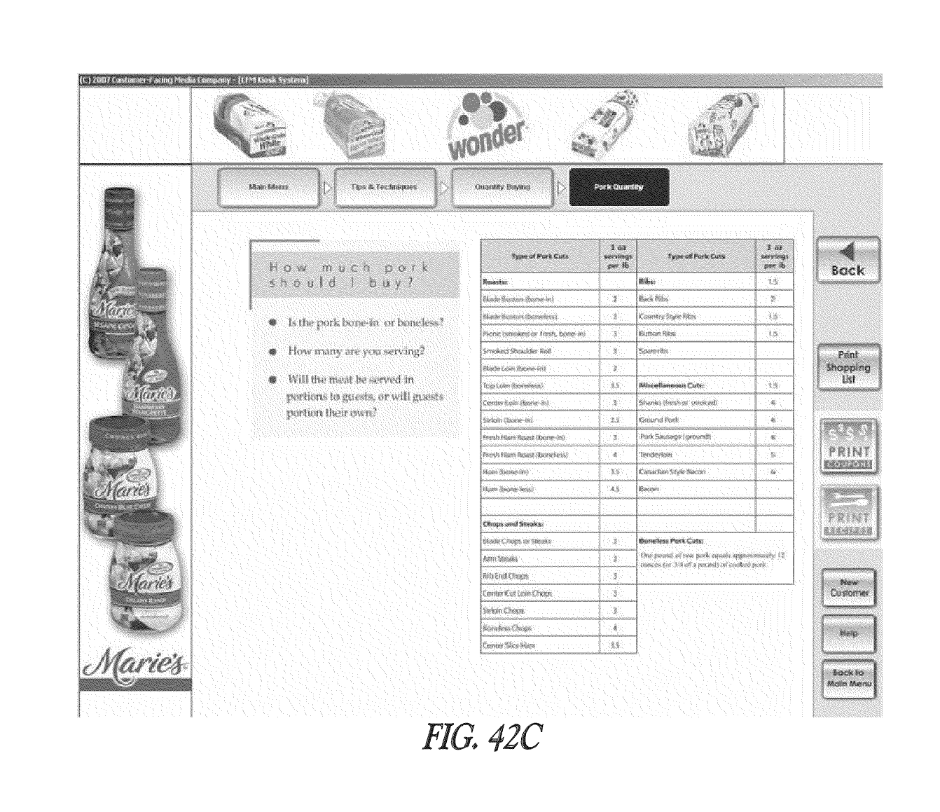

FIGS. 42A, 42B, and 42C are examples of the sequence of displays presented as a result of the consumer entering a consumable item through the graphical interface. The consumer is able to select a particular set of how-to instructions/recipe/article from among the responses related to the search upon seeing displayed a how-to instruction/recipe/product information article of interest to the consumer.

In this method, block 3710 depicts displaying to the consumer at least one incentive offering or advertisement substantially at the same time that the consumer receives the “how to” instructions.

Block 3712 depicts a consumer printing the selected how-to instruction/recipe/product information article Such selection may be done with a touch screen by pointing to the coupon/incentive offerings, and/or how-to instruction/recipe, and/or product information article, or by other selecting operation, including but not limited to navigational icons.

The flow chart diagram of FIG. 37A provides an example embodiment of a method 3701 according to the inventive subject matter described herein. In this method, block 3722 depicts a dispensing device located in a retail establishment, such as but not limited to the coupon dispensing devices described above. In this method, block 3724 depicts a consumer selecting to search a pool of at least one of the how-to instructions/recipes and/or product information articles by at least one consumable item incorporated in the how-to instruction/recipe/product information article. Further, block 3726 depicts the use of parameters in a database program to display a selected how-to instruction/recipe/product information article, along with any related advertisements, sponsored and/or paid brand recommendations, and/or coupon/incentive offerings for at least one consumable item incorporated in the selected how-to instruction/recipe/product information article. For example, displaying “Purdue®” Chicken in a recipe that is selected as a result of a search for “chicken” as a consumable item in a recipe.

According to still another example embodiment (FIG. 37B), the system and method illustrated above may include a method 3703 according to the inventive subject matter described herein. In this method, block 3742 depicts a dispensing device located in a retail establishment, such as but not limited to the coupon dispensing devices described above. In this method, block 3744 depicts a consumer selecting to search a pool of at least one how-to instructions/recipes and/or product information articles by at least one consumable item incorporated in the how-to instruction/recipe/product information article. Further, block 3746 depicts the use of parameters in a database program to display specific advertising and/or incentives (coupons) or product information on how to buy the consumable item(s) identified in the search response. In this method, block 3748 depicts a consumer printing the selected how-to instruction/recipe/product information article, including but not limited to any related advertisements, sponsored and/or paid brand recommendations, and/or coupon/incentive offerings for at least one consumable item incorporated in the selected how-to instruction/recipe/product information article. For example, printing “Purdue®” Chicken in the recipe that is selected as a result of a search for “chicken” as a consumable item in a recipe. Such selection to print the how-to instruction/recipe/product information article may be done with a touch screen by pointing to the how-to instruction/recipe/product information article, or by other selecting operation, including but not limited to navigational icons.

According to still another example embodiment, the system and method illustrated in FIG. 1A, include recording in a database each of the consumable items selected by a consumer to search a pool of at least one how-to instruction/recipe/product information article, and/or any or all how-to instruction/recipe/product information articles selected by a consumer, along with recording in a database the time the consumer spent viewing each selection. The method further includes, in combination with other methods, recording in a database which advertisements, how-to instructions/recipes, and/or product information articles are printed by the consumer. These methods are implemented in whole or in part as software executable on the processing unit of a dispensing device such as device 102, and data supporting such operation is also stored in a memory or data storage component on a dispensing device, such as device 102. Consumer interest in a particular consumable item and/or how-to instructions/recipe, and/or product information, and/or advertisement, as evidenced in the consumer selection data collected through the touch screen and other selecting operations is transmitted to at least one data collection system.

According to still another example embodiment, the system and method illustrated in FIG. 1A, further includes, using the parameters of a database, the display of a set of at least one coupon or type of incentive offering, and/or at least one how-to instructions/recipe, and/or at least one product information article, from a pool of coupons/incentive offerings, how-to instructions/recipes, and/or product information articles, along with associated advertisements, based on previous selections by this consumer, and/or selections based on the time spent on previous selections by this consumer, and/or selections based on previous selections by other consumers who made a similar pattern of selections, and/or selections based on the time spent on previous selections by other consumers who made a similar pattern of selections. According to this method, sets from a pool of at least one coupon or type of incentive offering, and/or at least one how-to instructions/recipe, and/or product information deemed similar in content or offer would be presented earlier in the sequence queue, or even suggested in a navigation icon. These methods are implemented in whole or in part as software executable on the processing unit of a dispensing device such as device 102, and data supporting such operation is also stored in a memory or data storage component on a dispensing device, such as device 102.

The system and method illustrated above with respect to FIG. 1A, further may include the use of a database program to determine the placement of one or more research questions on one or more reserved areas of the display in association with the display of at least one advertisement, and/or coupon or type of incentive offering, and/or at least one how-to instructions/recipe, and/or product information article accessed by a consumer using the device as a result of a search of a pool of at least one how-to instruction/recipe/product information article. Further the method, using the database, rotates through a pool of research questions, such that this method allows for starting the display order independently for each consumer and/or returning to the beginning of the queue when all questions have been displayed—without restarting for each consumer. Further the method, using the database, interrupts the rotation of the research questions, or coupon or type of incentive offering, or how-to instructions/recipe, or product information, in order to display a specific research question from a pool of research questions and then returns to a rotation through a pool of research questions, such that this method allows for starting the display order for each consumer and/or returning to the beginning of the queue when all research questions have been displayed—without restarting for each consumer. The method includes recording each consumer selection(s) in response to the research question(s) in a database along with recording in a database the time the consumer spent viewing each research question. Consumer response data is transmitted to at least one data collection system. These methods are implemented in whole or in part as software executable on the processing unit of a dispensing device such as device 102, and data supporting such operation is also stored in a memory or data storage component on a dispensing device, such as device 102.

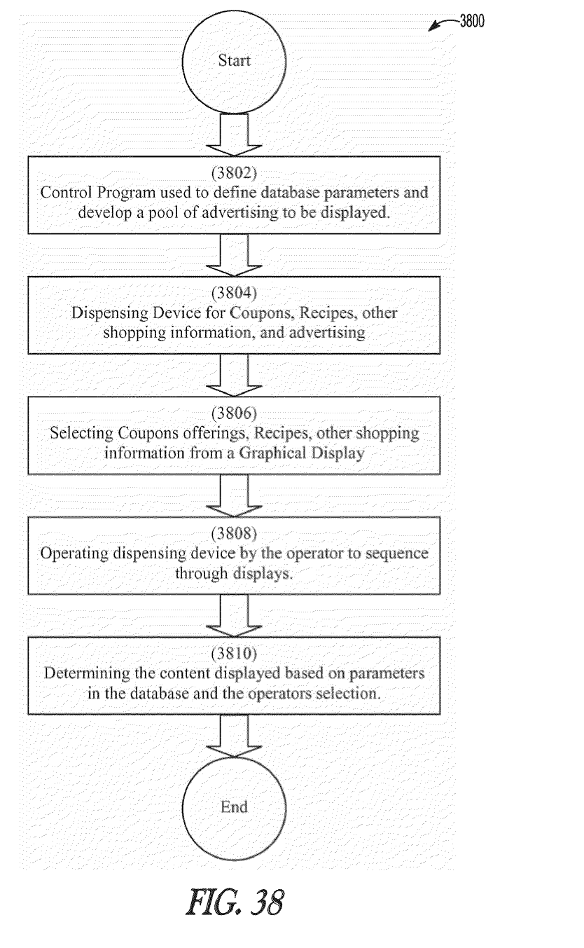

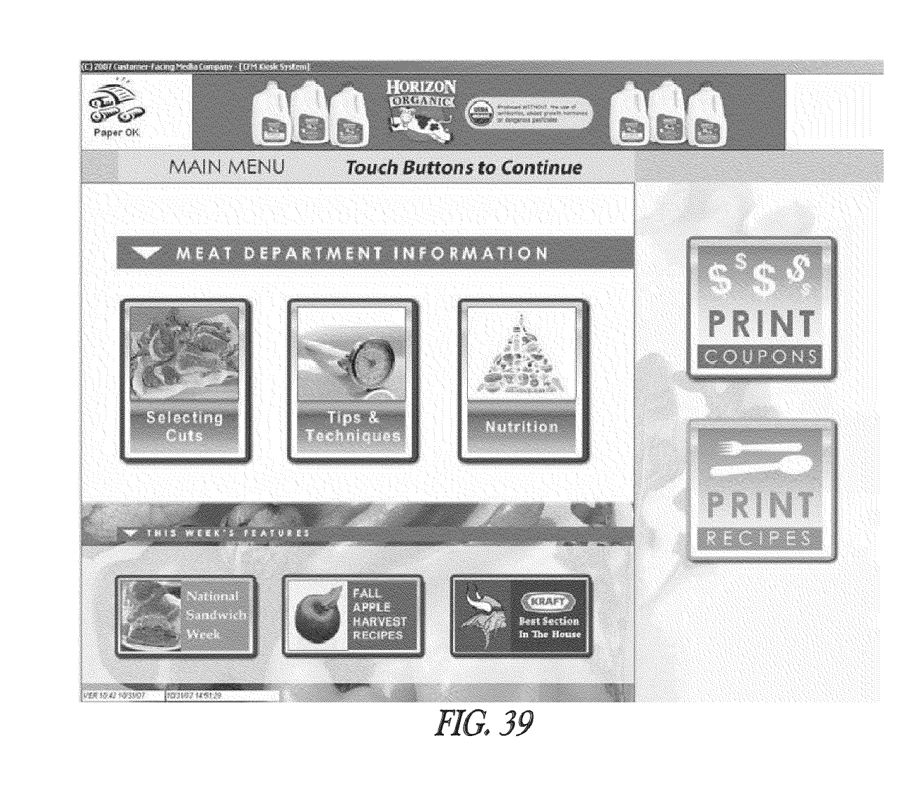

The flow chart diagram of FIG. 38 provides another example embodiment of a method 3800 according to the inventive subject matter described herein.

In this method, block 3804 depicts a dispensing device located in a retail establishment, such as but not limited to the coupon dispensing devices described above.

According to this method, in block 3806 the dispensing device displays on a graphical display, a plurality of coupon offerings and/or other type of incentive offering, and/or a plurality of how-to instructions for use of a product, including but not limited to recipes, and/or a plurality of product information articles helpful to a consumer making a purchase decision in a retail establishment such as those shown in FIGS. 39, 40, 41A, 41B, 41C, 41D, 41E, 42A, 42B, 42C.

According to this method, the coupons and/or other incentive offerings, how-to instructions and/or recipes, and/or product information articles are for goods or services offered for sale at the retail establishment.

As depicted in block 3808, a consumer operates the dispensing device to select which content is to appear on the display. The consumer selects one of the coupon/incentive offerings and/or one of the how-to instructions/recipes to print. Such selection may be done with a touch screen by pointing to the selected coupon/incentive offering and/or how-to instruction/recipe, or by other selecting operation, including but not limited to navigational icons.

According to this method, block 3810 further includes the use a database program (FIG. 1A), the parameters of which determine the placement of one or more advertisements on one or more reserved areas of the display, including but not limited to a method of layering the content to be displayed, and in association with at least one coupon or type of incentive offering, and/or at least one how-to instructions/recipe, and/or product information article accessed by a consumer using the device to sequence through various displays in a unique sequence determined by the consumer.

Further the method, using the parameters in the database, interrupts the predetermined rotation of advertisements in order to display a specific advertisement from a pool of ads in association with a specific display of at least one coupon or type of incentive offering, and/or at least one how-to instructions/recipe, and/or product information article accessed by the consumer, and then resumes a rotation through a pool of ads, such that this method allows for starting the display order for each consumer and/or returning to the beginning of the queue when all advertisements have been displayed—without restarting for each consumer.

FIGS. 39-43B illustrate generally a screen display of the system disclosed herein including various layouts in accordance with the above description.

### Examples

In an example, the system or method described herein (e.g., a coupon dispensing system) can include one or more than one touch screen for each system. Exemplary embodiments are listed below.

1. A system, comprising:

a) one or more processing units;

b) at least two touch screen units including a display and a system to detect selections made by a consumer by touching the screen unit;

c) at least one network connection;

d) at least one data storage device;

e) at least one output device;

f) one or more computer programs operative on the one or more processing units to:

g) access a plurality of incentive offerings;

h) access a plurality of advertisements;

i) respond to inputs received from respective consumers each independently interacting with the touch screen units and display at least one of the incentive offerings to the respective consumers at least in part responsive to touch inputs received from the respective consumers;

j) display advertisements on both of the at least two touch screen units, wherein the advertisements are displayed simultaneously with the display of incentive offerings to a consumer interacting with the respective touch screen unit or at times when a consumer is not interacting with the respective touch screen unit.

2. A system according to claim 1 further wherein the or more computer programs are operative on the one or more processing units to:

k) outputting an incentive offering on the at least one output device.

3. A system according to claim 2 further wherein the output device is a printer or a data transfer device.

In an example, the system or method described herein can include one or more than one printer for each system. Exemplary embodiments are listed below.

4. A coupon dispensing system, comprising a plurality of dispensing devices located in retail establishments, wherein each dispensing device includes a kiosk unit including:

a) one or more processing units;

b) one or more touch screen displays;

c) a modem and/or network connection;

d) a storage device;

e) one or more printers

5. A control system capable of exchanging information with dispensing devices, wherein the control system includes:

a) maintain library of coupon offerings;

b) send coupon offering information to dispensing devices;

c) collect and operate on data received from coupon dispensing devices;

d) provide a web interface accessible over the Internet to provide for viewing of selected dispensing system data; and

6. A coupon offering authoring tool to prepare coupon offering data to be used to display coupon offerings by the dispensing devices.

7. The system of any one or more of claims 1-6 wherein the retail establishment offers a product or service or entertainment to a consumer.

8. A method comprising: on a coupon dispensing device located in a retail establishment, displaying a selection of coupon offerings on a graphical display, wherein the coupons are for goods or services offered for sale at the retail establishment; a consumer operating the dispensing device to select a coupon offering for printing.

In an example, the system or method described herein (e.g., a coupon dispensing system) can include one or more than one touch screen configured to group or segment consumer interactions. Exemplary embodiments are listed below.

9. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) a proximity detection system to detect a movement or presence of a consumer;

g) one or more computer programs operative on the one or more processing units to:

h) access a plurality of incentive offerings;

i) during a first period of time respond to inputs received from interactions of a consumer with the touch screen unit and display at least one of the incentive offerings at least in part responsive to touch inputs received at the touch screen unit;

j) during a second period of time following the first period of time respond to inputs received from interactions of a consumer with the touch screen unit and display at least one of the incentive offerings at least in part responsive to touch inputs received at the touch screen unit;

k) record a plurality of interaction indications of at least some of the interactions of the consumers with the touch screen unit, wherein at least some of the interaction indications are time stamped;

l) recording and time stamping a plurality of indications of proximity of the consumers to the touch screen unit, wherein the indications are based at least in part on output from the proximity detection system; and

m) wherein the time stamped interaction indications or indications of proximity are recorded at least in part in the data storage device.

10. A system according to any one or more of claims 1-9 further including at least one computer program operative on the one or more processing units or on one or more other processing units to segment or group the time stamped indications of interactions with the touch screen display wherein the segmenting or grouping is accomplished using at least in part the time stamped indications.

11. A system according to any one or more of claims 1-10 further wherein the or more computer programs are operative on the one or more processing units to:

k) outputting an incentive offering on the at least one output device.

12. A system according to any one or more of claims 1-11 further wherein the output device is a printer or a data transfer device.

13. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) during a first period of time respond to inputs received from interactions of a consumer with the touch screen unit and display at least one of the incentive offerings at least in part responsive to touch inputs received at the touch screen unit;

i) during a second period of time following the first period of time respond to inputs received from interactions of a consumer with the touch screen unit and display at least one of the incentive offerings at least in part responsive to touch inputs received at the touch screen unit;

j) record a plurality of time stamped indications of at least some of the interactions of the consumers with the touch screen unit;

k) recording and time stamping a plurality of indications of proximity of the consumers to the touch screen unit, wherein the indications are based at least in part on output from the proximity detection system; and

l) wherein the time stamped indications of interactions are recorded at least in part in the data storage device.

14. A system according to any one or more of claim 1-13 wherein the one or more computer programs are operative on the one or more processing units to display to a consumer interacting with the touch screen unit a request to indicate that the consumer is still present or to indicate that a new consumer has arrived at the touch screen unit.

15. A system according to any one or more of claims 1-14 wherein the request to indicate is displayed approximately X seconds or less after the last interaction with the touch screen unit has occurred.

16. A system according to any one or more of claims 1-15 further including at least one computer program operative on the one or more processing units or on one or more other processing units to segment or group the time stamped indications of interactions with the touch screen display according to one or more predetermined criteria or at least one algorithm.

17. A system according to any one or more of claims 1-16 further wherein the or more computer programs are operative on the one or more processing units to:

k) outputting an incentive offering on the at least one output device.

18. A system according to any one ore more of claims 1-17 further wherein the output device is a printer or a data transfer device.

19. A method comprising:

using a proximity detector on the dispensing device to detect the presence of a consumer at a device; and

associating coupons together that were printed while the proximity detector indicated that a person was in continuous proximity to the device so that coupons selected by the same or what appears to be the same person can be determined.

20. The method of claim 19 wherein the retail establishment offers a product or service or entertainment to a consumer.

21. The method of claim 19 wherein printed coupons include a bar code.

22. A method according to claim 19 further including in addition to coupons, displaying information that would be useful to consumers considering a purchase along with one or more advertising messages paid by a third party(ies).

23. A method comprising:

on a coupon dispensing device located in a retail establishment, displaying a selection of coupon offerings on a graphical display, wherein the coupons are for goods or services offered for sale at the retail establishment;

displaying the coupon offerings in two or more groups, wherein one group is displayed at a time;

a consumer operating the dispensing device to sequence through displays of groups on the display; and using a telephone line and modem to periodically download coupon offering data into the dispensing device.

24. The method of claim 23 wherein the retail establishment offers a product or service or entertainment to a consumer.

25. A method according to claim 23 further including in addition to coupons, displaying information that would be useful to consumers considering a purchase along with one or more advertising messages paid by a third party(ies).

In an example, the system or method described herein (e.g., a coupon dispensing system) can include sequencing display incentives. Exemplary embodiments are listed below.

26. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) in response to inputs received from a consumer, display incentive offerings in a sequence to the consumer so that the consumer is required to view incentive offerings in a sequence where at any point in time less than all of the plurality of incentive offerings are displayed, and wherein at any point in time one or more incentive offerings are displayed, and further wherein the consumer causes the incentive displays to move from one display to the next in the sequence by selecting a single push-button and wherein the button is a real or virtual push-button;

i) receiving an input from a consumer in response to one of the displays in the sequence wherein the input indicates the consumer is interested in the incentive offering and determining which of the incentive offerings are of most interest to consumers that interact with the touch screen unit substantially within a particular period of time; and

j) arranging the sequence of display of incentive offerings so that at least some of the incentive offerings of most interest to the consumers are positioned so as to encourage consumers viewing the sequence to view less popular incentive offerings as well as more popular incentive offerings.

27. A system according to claim 26 wherein a group of incentive offerings are displayed at one time in the sequence of displays, and wherein the group includes two or more incentive offerings.

28. A system according to claim 26 further wherein the or more computer programs are operative on the one or more processing units to:

k) outputting an incentive offering on the at least one output device.

29. A system according to claim 28 further wherein the output device is a printer or a data transfer device.

30. A system according to claim 26 wherein at least some of the plurality of incentive offerings form a set of incentive offerings that are selected to be displayed at any particular point in time or during any particular period of time.

31. A system according to claim 26 wherein the plurality of incentive offerings displayed in the sequence are chosen at least in part based on the location of the touch screen unit on the floor of an establishment or the geographical location of the touch screen unit, or based on both.

32. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) in an attract mode, display one or more of the incentive offerings determined to be of relatively more interest to a consumer than others of the incentive offerings;

h) in response to inputs received from a consumer, display the incentive offerings in a sequence to the consumer so that the consumer is required to view incentive offerings in a sequence where at any point in time less than all of the plurality of incentive offerings are displayed, and wherein at any point in time one or more incentive offerings are displayed, and further wherein the consumer causes the incentive displays to move from one display to the next in the sequence by selecting a single push-button and wherein the button is a real or virtual push-button; and

i) arranging the sequence of display of incentive offerings so that the consumer is required to view incentive offerings that are of less interest in order to access one or more incentive offerings that are of relatively more interest.

33. A method comprising: on a coupon dispensing device located in a retail establishment, displaying a selection of coupon offerings on a graphical display, wherein the coupons are for goods or services offered for sale at the retail establishment;

displaying the coupon offerings in one or more groups, wherein one group is displayed at a time; and

a consumer operating the dispensing device to sequence through displays of groups on the display. For example, sequence from group 402 to group 404 to group 406.

34. The method of claim 3 wherein the retail establishment offers a product or service or entertainment to a consumer.

35. A method according to claim 33 further including in addition to coupons, displaying information that would be useful to consumers considering a purchase along with one or more advertising messages paid by a third party(ies).

36. A method comprising:

on a coupon dispensing device located in a retail establishment, displaying a selection of coupon offerings on a graphical display, wherein the coupons are for goods or services offered for sale at the retail establishment;

displaying the coupon offerings in two or more groups, wherein one group is displayed at a time;

a consumer operating the dispensing device to sequence through displays of groups on the display; and

wherein at least some of the groups of coupon offerings have about 6 to 18 offerings in them and wherein the device permits a consumer to advance from the display of one group to the next by making one input to the device.

37. The method of claim 36 wherein the retail establishment offers a product or service or entertainment to a consumer.

38. The method according to claim 36 further wherein the number of coupon offerings is about 12, the number of groups is about 3 and further wherein the one input is made by pressing a physical button on the device or a button icon on a touch screen display.

39. A method according to claim 32 further including in addition to coupons, displaying information that would be useful to consumers considering a purchase along with one or more advertising messages paid by a third party(ies).

40. A method comprising: on a coupon dispensing device “located in a retail establishment, displaying a selection of coupon offerings on a graphical display, wherein the coupons are for goods or services offered for sale at the retail establishment; displaying the coupon offerings in two or more groups, wherein one group is displayed at a time; a consumer operating the dispensing device to sequence through displays of groups on the display;

wherein there is allocated a desired number of display positions on the display to be used to display the coupon offerings in a group; and wherein if there are not enough coupon offerings available to display in the total number of display positions available while sequencing through groups of coupon offerings, redisplaying one more or more of the same coupon offerings previously displayed in a different group so that all display groups are filled with a coupon offering.

41. The method of claim 40 wherein the retail establishment offers a product or service or entertainment to a consumer.

42. A method according to claim 40 further including in addition to coupons, displaying information that would be useful to consumers considering a purchase along with one or more advertising messages paid by a third party(ies).

43. A method comprising: on a coupon dispensing device located in a retail establishment, displaying a selection of coupon offerings on a touch-screen graphical display, wherein the coupons are for goods or services offered for sale at the retail establishment; displaying the coupon offerings in two or more groups, wherein one group is displayed at a time;

a consumer operating a single input mechanism on the dispensing device to sequence through displays of groups on the display; and a consumer using the touch screen to touch the screen near a displayed coupon offering the consumer wishes to print in order to print the desired coupon offering.

44. The system of claim 43 wherein the retail establishment offers a product or service or entertainment to a consumer.

45. The method of claim 43 wherein printed coupons include a bar code.

46. A method according to claim 43 further including in addition to coupons, displaying information that would be useful to consumers considering a purchase along with one or more advertising messages paid by a third party(ies).

In an example, the system or method described herein (e.g., a coupon dispensing system) can change the order of a sequence. Exemplary embodiments are listed below.

47. A method comprising: on a coupon dispensing device located in a retail establishment, displaying a selection of coupon offerings on a graphical display, wherein the coupons are for goods or services offered for sale at the retail establishment; displaying the coupon offerings in two or more groups, wherein one group is displayed at a time;

in an attract mode, displaying a particular set of coupon offerings that are premium in comparison to the other coupon offerings displayed in the two or more groups; and a consumer operating the dispensing device to sequence through displays of groups on the display wherein the offerings having an order in which they are displayed in the groups.

48. The method of claim 47 wherein the retail establishment offers a product or service or entertainment to a consumer.

49. The method of claim 47 wherein printed coupons include a bar code.

50. A method according to claim 47 further including in addition to coupons, displaying information that would be useful to consumers considering a purchase along with one or more advertising messages paid by a third party(ies).

51. A method comprising:

on a coupon dispensing device located in a retail establishment, displaying a selection of coupon offerings on a graphical display, wherein the coupons are for goods or services offered for sale at the retail establishment;

displaying the coupon offerings in two or more groups, wherein one group is displayed at a time; a consumer operating the dispensing device to sequence through displays of groups on the display wherein the offerings having an order in which they are displayed in the groups; and

changing the order of the offerings based on the location of the device in the establishment.

52. The method of claim 51 wherein the retail establishment offers a product or service or entertainment to a consumer.

53. A method according to claim 51 further including in addition to coupons, displaying information that would be useful to consumers considering a purchase along with one or more advertising messages paid by a third party(ies).

54. A method comprising:

on a coupon dispensing device located in a retail establishment, displaying a selection of coupon offerings on a graphical display, wherein the coupons are for goods or services offered for sale at the retail establishment;

displaying the coupon offerings in two or more groups, wherein one group is displayed at a time; a consumer operating the dispensing device to sequence through displays of groups on the display wherein the offerings having an order in which they are displayed in the groups;

and changing the order of the offerings based on the time of day or day of week or both as previous selection.

55. The method of claim 54 wherein the retail establishment offers a product or service or entertainment to a consumer.

56. A method according to claim 54 further including in addition to coupons, displaying information that would be useful to consumers considering a purchase along with one or more advertising messages paid by a third party(ies).

57. A method comprising:

on a coupon dispensing device located in a retail establishment, displaying a selection of coupon offerings on a graphical display, wherein the coupons are for goods or services offered for sale at the retail establishment;

displaying the coupon offerings in two or more groups, wherein one group is displayed at a time; a consumer operating the dispensing device to sequence through displays of groups on the display wherein the offerings having an order in which they are displayed in the groups;

and changing the order of the offerings based on the number of offers printed at each location.

58. The method of claim 57 wherein the retail establishment offers a product or service or entertainment to a consumer.

59. A method according to claim 57 further including in addition to coupons, displaying information that would be useful to consumers considering a purchase along with one or more advertising messages paid by a third party(ies).

In an example, the system or method described herein (e.g., a coupon dispensing system) can include companion ads, incentive limits, and incentive substitution.

IV-1. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) access a plurality of advertisements;

i) associating at least one advertisement or type of advertisement with at least one incentive offering or type of incentive offering;

j) displaying the at least one advertisement and the at least one incentive offering at least in part at the same time based on the associations between the advertisements and the incentive offerings.

IV-2. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) displaying at least one incentive offering;

i) a consumer selecting the incentive offering;

j) ceasing to display the incentive offering or substituting a different incentive offering for the at least one incentive offering according to at least one cessation or substitution criteria.

IV-2-a. A system according to claim IV-2 wherein the cessation or substitution criteria is the number of times an incentive offering has been printed by a consumer.

IV-2-b. A system according to claim IV further wherein the or more computer programs are operative on the one or more processing units to:

k) outputting an incentive offering on the at least one output device.

IV-2-c. A system according to claim IV-b further wherein the output device is a printer or a data transfer device.

17. A method comprising: on a coupon dispensing device located in a retail establishment, displaying a selection of coupon offerings on a graphical display, wherein the coupons are for goods or services offered for sale at the retail establishment; displaying the coupon offerings in two or more groups, wherein one group is displayed at a time; a consumer operating the dispensing device to sequence through displays of groups on the display and selecting one of the coupon offerings to print a corresponding coupon; and

wherein following the selection of the coupon offering displaying a related coupon offering to entice the consumer to select the related coupon offering in addition to the selected coupon offering.

18. The method of claim I7 wherein the retail establishment offers a product or service or entertainment to a consumer.

I8A. A method according to claim I7 further including in addition to coupons, displaying information that would be useful to consumers considering a purchase along with one or more advertising messages paid by a third party(ies).

I18. A method comprising:

on a coupon dispensing device located in a retail establishment, displaying a selection of coupon offerings on a graphical display, wherein the coupons are for goods or services offered for sale at the retail establishment; displaying the coupon offerings on the device; a consumer operating the dispensing device and selecting one of the coupon offerings to print a corresponding coupon; and

in addition to printing the coupon selection selected by the consumer, printing one or more related coupons to entice the consumer to use a related coupon in addition to the coupon selected for printing.

I19. The method of claim I18 wherein the retail establishment offers a product or service or entertainment to a consumer.

I20. The method of claim I18 wherein printed coupons include a bar code.

I21A. A method according to claim I18 further including in addition to coupons, displaying information that would be useful to consumers considering a purchase along with one or more advertising messages paid by a third party(ies).

14. A method comprising:

on a coupon dispensing device located in a retail establishment, displaying a selection of coupon offerings on a graphical display, wherein the coupons are for goods or services offered for sale at the retail establishment; displaying the coupon offerings in two or more groups, wherein one group is displayed at a time; a consumer operating the dispensing device to display and select coupon offerings for

printing; and

in response to a count of the number of coupons printed for a particular coupon offering stopping the display of the particular coupon offering on the device.

15. The method of claim 14 wherein the retail establishment offers a product or service or entertainment to a consumer.

16. The method of claim 14 wherein printed coupons include a bar code.

17. The method of claim 14 further including substituting a different coupon offering for the particular one for which the display of which was stopped.

17A. A method according to claim 14 further including in addition to coupons, displaying information that would be useful to consumers considering a purchase along with one or more advertising messages paid by a third party(ies).

11. A method comprising: on a coupon dispensing device located in a retail establishment, displaying a selection of coupon offerings on a graphical display, wherein the coupons are for goods or services offered for sale at the retail establishment; displaying the coupon offerings in two or more groups, wherein one group is displayed at a time; a consumer operating the dispensing device to display and select coupon offerings for printing; and

at the request of the retail establishment or a sponsor for a coupon offering substituting a different coupon offering for one of the coupon offerings priority displayed by the device.

12. The method of claim 11 wherein the retail establishment offers a product or service or entertainment to a consumer.

13. The method of claim 11 wherein printed coupons include a bar code.

13A A method according to claim 11 further including in addition to coupons, displaying information that would be useful to consumers considering a purchase along with one or more advertising messages paid by a third party(ies).

In an example, the system or method described herein (e.g., a coupon dispensing system) can include ordering food features. Exemplary embodiments are listed below.

V. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of collateral offerings;

h) receive an order for a product or service from inputs to the touch screen units;

i) displaying at least one collateral offering at about the same time that the order is received;

j) wherein the collateral offering is selected from the group: an incentive offering, a recipe, “how to” instructions, or an advertisement.

21. A method comprising:

on a computerized device located in a food service establishment, receiving an electronic order from a consumer who inputs their food service choice into the device; following entry of the consumer's choice,

displaying a selection of coupon offerings on a graphical display, wherein the coupons are for goods or services offered for sale at the food service establishment and which are related to the food choice made by the consumer; and

a consumer operating the dispensing device and selecting one of the coupon offerings to print a corresponding coupon at the device.

22. The method of claim 21 wherein the retail establishment offers a product or service or entertainment to a consumer.

23. The method of claim 21 wherein printed coupons include a bar code.

24. A method according to claim 21 further including selling ad space.

25. A method according to claim 21 further including automatically making ad from advertiser information.

In an example, the system or method described herein (e.g., a coupon dispensing system) can include displaying consumer content with advertising.

IV-1. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) access a plurality of advertisements;

h-ii) access a plurality of recipes or “how to” instructions;

i) associating at least one advertisement or type of advertisement with at least one incentive offering or type of incentive offering;

i-ii) associating at least one recipe/how to instruction or type of recipe/how to instruction with at least one incentive offering or type of incentive offering

j) displaying the at least one advertisement or recipe/how to instruction and the at least one incentive offering at least in part at the same time based on the associations between the advertisements and the incentive offerings.

In an example, the system or method described herein (e.g., a coupon dispensing system) can include displaying consumer content with advertising.

42. A method for displaying one or more pools of content. Use a database program to determine the content that is displayed at a location. Place the delivery system consisting of a processing unit, one or more displays, a storage device, one or more printers and a communication device inside the retail establishment in the aisles where merchandise is offered for sale.

Display in two or more groups, wherein one group is displayed at a time; a consumer operating the device can select product information on how to buy or use products for sale in the retail establishment, including instructions (recipes), tips or techniques for using products or item selection criteria or comparisons along with advertisements and/or incentives (coupons). Allow the consumer to advance through several different displays.

43. A method according to claim 42 further allowing the customer to select items of interest from the pool to print out.

44. A method according to claim 42 further including the use a database program to determine the placement of one or more advertisements on one or more layers in front of the content. Using the database, rotate through the pool of ads. This method allows for starting the display order for each consumer (guarantees “early” ads will always be seen) or returning to the beginning of the queue when all advertisements have been displayed—without restarting for each consumer.

45. A method according to claim 42 further including in combination with other methods, use of a database program to determine which advertisements and/or incentives are displayed at that particular location.

46. A method according to claim 42 further including in combination with other methods, the use of a database program to determine which advertisements and/or incentives are displayed at that time of day.

47. A method according to claim 42 further including in combination with other methods, the use of a database program to determine which advertisements and/or incentives are displayed by day of the week.

48. A method according to claim 42 further including in combination with other methods, the use of a database program to determine which advertisements and/or incentives are displayed based on the number of times an advertisement and/or incentive has been displayed.

49. A method according to claim 42 further including in combination with other methods, the use of a database program to display selections based on previous selections by this customer.

50. A method according to claim 42 further including in combination with other methods, the use of a database program to display selections based on previous selections by other customers who made the same pattern of selections.

51. A method according to claim 42 further including in combination with other methods, the use of a database program to display selections based on the time spent on previous selections by this customer. Those selections deemed similar in content or offer would be presented earlier in the queue, or even suggested in a navigation icon, to the user based on the pattern of the time spent on the displays they have viewed.

52. A method according to claim 42 further including in combination with other methods, use of a database program to display selections based on the time spent on previous selections by other customers who made the same pattern of selections. Those selections deemed similar in content or offer would be presented earlier in the queue, or even suggested in a navigation icon, to the current user based on the pattern of the time spent on the displays other users have viewed.

In an example, the system or method described herein (e.g., a coupon dispensing system) can include dynamic ads. Exemplary embodiments are listed below.

In an example, the system or method described herein (e.g., a coupon dispensing system) can include measuring consumer interest. Exemplary embodiments are listed below.

VIII. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) access a plurality of advertisements;

i) access a plurality of recipes or “how to” instructions;

j) presenting to a consumer interacting with the touch screen unit at least one item selected from the group: the incentive offerings, the advertisements or the recipe/how to instructions;

k) receiving at least one input from the consumer that evidences interest in an item displayed to the consumer;

l) transmitting information evidencing the consumer interest to at least one data collection system.

53. A Method for displaying one or more pools of content. Use a database program to determine the content that is displayed at a location. Place the delivery system consisting of a processing unit, one or more displays, a storage device, one or more printers and a communication device inside the retail establishment in the aisles where merchandise is offered for sale.

Display in two or more groups, wherein one group is displayed at a time; a consumer operating the device can select product information on how to buy and use products for sale in the retail establishment, including instructions (recipes), tips and techniques for using products and item selection criteria and comparisons along with advertisements and incentives (coupons). Allow the consumer to advance through several different displays.

The customer would then select items of interest from the pool to print out.

Allow the consumer to advance through several different displays using navigational icons provided on a touch screen. Record each selection in a database. Transmit the results to a central collection point for analysis and dissemination.

54. A method according to claim 53 further allowing the consumer to advance through several different displays; recording in a database the time the consumer spent viewing each selection. Transmit the results to a central collection point for analysis and dissemination.

55. A method according to claim 53 further including in combination with other methods, recording in a database which advertisements, instructions (recipes) and/or incentives (coupons) are printed. Transmit the results to a central collection point for analysis and dissemination to advertisers.

56. A method according to claim 53 further allowing the customer to respond to one or more market research questions and recording the answers in a database. Use the communication device to report the responses back to a central database for analysis and dissemination.

57. A method according to claim 56 further including an incentive (coupon) to customers for participating in the study.

In an example, the system or method described herein (e.g., a coupon dispensing system) can include a shopping list. Exemplary embodiments are listed below.

IX. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) access a plurality of advertisements;

i) access a plurality of recipes or “how to” instructions;

j) presenting to a consumer interacting with the touch screen unit at least one data item selected from the group: the incentive offerings, the advertisements or the recipe/how to instructions;

k) receiving at least one input from the consumer that evidences interest in an data item displayed to the consumer;

l) generating a shopping list for the consumer based on items the consumer indicates an interest in, wherein the shopping list includes product items selected from the group: an product item associated with an incentive offering, a product item associated with an advertisement, or a product item associated with a recipe/“how to” instruction.

IX-a. A system according to claim IX further wherein the or more computer programs operative on the one or more processing units to produce an indication of where a product item on a shopping list is located in a shopping establishment.

58. A Method for displaying one or more pools of content. Use a database program to determine the content that is displayed at a location. Place the delivery system consisting of a processing unit, one or more displays, a storage device, one or more printers and a communication device inside the retail establishment in the aisles where merchandise is offered for sale.

Display in two or more groups, wherein one group is displayed at a time; a consumer operating the device can select product information on how to buy and use products for sale in the retail establishment, including instructions (recipes), tips and techniques for using products and item selection criteria and comparisons along with advertisements and incentives (coupons). Allow the consumer to advance through several different displays.

The customer would then select items of interest from the pool to print out.

Allow the consumer a choice to print a shopping list that consists of each item necessary to prepare or follow the instructions (recipes) they have previously selected along with all advertisements and/or incentives printed.

In an example, the system or method described herein (e.g., a coupon dispensing system) can include monitoring the status of paper. Exemplary embodiments are listed below.

X. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access at least one item selected from the group: a plurality of incentive offerings, a plurality of advertisements, or a plurality of recipes or “how to” instructions;

j) presenting to a consumer interacting with the touch screen unit at least one data item selected from the group: the incentive offerings, the advertisements or the recipe/how to instructions;

k) printing at least one data item selected by a consumer from the group presented to the consumer, wherein the data items are printed from a stock of paper;

l) determining, at least in part based on items printed for consumers in the past, a prediction of how much paper will be required during at least one upcoming time period.

59. A Method for monitoring the status of paper and other consumables in a remote device.

Use a database program to determine the content that is displayed at a location. Place the delivery system consisting of a processing unit, one or more displays, a storage device, one or more printers and a communication device inside the retail establishment in the aisles where merchandise is offered for sale. Display in two or more groups, wherein one group is displayed at a time; a consumer operating the device can select product information on how to buy and use products for sale in the retail establishment, including instructions (recipes), tips and techniques for using products and item selection criteria and comparisons along with advertisements and incentives (coupons). Allow the consumer to advance through several different displays. The customer would then select items of interest from the pool to print out.

Record which documents are printed in a database. Collect in a database the length of each document.

60. A method according to claim 59 further including in combination with other methods, a calculation of the number of users by time of day and day of week. Using the data collected over time and the document length, predict the number of hours left in the paper and other consumable supplies at that location.

61. A method according to claim 59 further including in combination with other methods, indicate on one or more displays an icon that would indicate how soon the paper at that location will run out and/or display the number of documents that can be printed with the remaining supply of consumables.

62. A method according to claim 59 further including in combination with other methods, collect contact information (fax, email, text) from the remote retail location in a database. Use the predicted number of hours left in the consumable supply to automatically notify the remote retail location with a fax, email or text message that the consumable supply needs to be replenished.

In an example, the system or method described herein (e.g., a coupon dispensing system) can includes an immersive environment. Exemplary embodiments are listed below.

XI. A system, comprising:

a) one or more processing units;

b-1) at least one touch screen unit including a display and a system to detect selections made by a consumer by touching the screen unit;

b-2) at least one display unit positioned on the floor and/or above the consumer and/or on the sides of the consumer while standing in front of the touch screen unit;

b-3) at least one speaker;

b-4) optionally at least one scent generating unit;

c) at least one network connection;

d) at least one data storage device;

e) at least one data output device;

f) one or more computer programs operative on the one or more processing units to:

g) access at least one item selected from the group: a plurality of incentive offerings, a plurality of advertisements, or a plurality of recipes or “how to” instructions;

j) presenting to a consumer interacting with the touch screen unit at least one data item selected from the group: the incentive offerings, the advertisements or the recipe/how to instructions;

k) displaying an immersive advertising presentation to the consumer standing in front of the touch screen unit.

In certain examples, claims made regarding the use of multiple digital displays and other devices to create a sales environment.

69. An advertising immersion display system, comprising a plurality of displaying devices located in retail establishments, wherein working collectively each immersion display device includes:

a) one or more processing units;

b) one or more touch screen displays;

c) a modem and/or network connection;

d) a storage device;

e) one or more printers

f) one or more digital monitors

g) one or more scent emitting devices

h) one of more sound emitting devices (speakers, headphones, sound shower)

In another example, the system of method includes a control system capable of exchanging information with the displaying devices, wherein the control system includes:

a) a library of images, sounds, scents, product information and advertising;

b) an incentive authoring program that initiates and manages and dispenses to consumers;

c) collects and operates on data received from displaying;

d) provide a web interface accessible over the Internet to provide for viewing of selected system data; and

Based on the user's selection of the content to be displayed, use a database program to determine the content displayed on additional screens associated with the main display. The effect of which is “customer immersion” with several displays interacting together to create a digital environment for the user.

70. A method according to claim 69 further including, in combination with other methods and based on the user's selection of the content to be displayed, use a database program to determine if sounds and/or scents should be emitted. It is possible that some sounds and scents would be timed to appear either before or after the content is displayed on the main screen. The effect of which is “customer immersion” with several displays interacting together to create an environment for the user.

In an example, the system or method described herein (e.g., a coupon dispensing system) can include item location or an item locator. Exemplary embodiments are listed below.

XII. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) access a plurality of advertisements;

i) access a plurality of recipes or “how to” instructions;

j) receiving at least one input from a consumer at the touch screen display unit, wherein the input pertains to a request by the consumer for information concerning the location of a product to purchase within a business establishment;

k) presenting to the consumer entering the at least one input at least one data item selected from the group: the incentive offerings, the advertisements or the recipe/how to instructions.

In an example, the system or method described herein (e.g., a coupon dispensing system) can include item location with advertising. Exemplary embodiments are listed below.

74. A Method for searching one or more pools of content to identify the particular location of an item in a retail establishments and presenting product information and/or advertisements during the item search. Place the delivery system consisting of a processing unit, one or more displays, a touch screen, a storage device and a communication device inside the retail establishment in the aisles where merchandise is offered for sale. Display a graphical interface wherein a consumer operating the device can begin a search for the location of a particular item. While the search is being conducted, use a database program to determine the placement of one or more advertisements or general product information on how to buy or use products for sale in the retail establishment including instructions (recipes), tips or techniques for using products, on one or more layers in front of the search content. Using the database, rotate through the pool of advertisements and/or instructions.

75. A method according to claim 74 further including, in combination with other methods and based upon the response to the database search initiated by the user, the use of a database program to display specific advertising and/or incentives (coupons) or product information on how to buy or instructions (recipes) on the use of the item identified in the search response.

76. A method according to claim 74 further including, in combination with other methods and based upon the response to the database search initiated by the user and on previous selections by other users who made the same pattern of selections, the use of a database program to display specific recommendations for additional non-searched items, including advertising and/or incentives (coupons) or recommendation or product information on how to buy or use the item identified in the search response, including instructions (recipes), tips or techniques for use.

77. A method according to claim 74 further including, in combination with other methods, including item location on a printed shopping list comprised of components in instructions (Example ingredients in recipes) and other information selected by a consumer in a retail store.

78. A method according to claim 74 further including in combination with other methods, recording in a database which items were searched by consumers. Transmit the results to a central collection point for analysis and dissemination to advertisers.

79. A method according to claim 74 further allowing the customer to respond to one or more market research questions and recording the answers in a database. Use the communication device to report the responses back to a central database for analysis and dissemination.

In an example, the system or method described herein (e.g., a coupon dispensing system) can include instructions with advertising. Exemplary embodiments are listed below.

XIII. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) access a plurality of advertisements;

i) access a plurality of recipes or “how to” instructions;

j) receiving at least one input from a consumer at the touch screen display unit, wherein the input pertains to a request by the consumer for information concerning an item selected from the group: a consumable item usable in a recipe or an article or substance that may be used in a “do it yourself” project;

k) presenting to the consumer entering the at least one input “how to” instructions, for example a recipe, related to the request;

l) displaying to the consumer at least one incentive offering or advertisement substantially at the same time that the consumer receives the “how to” instructions.

In an example, the system or method described herein (e.g., a coupon dispensing system) can include instruction search (e.g., recipe search) with advertising. Exemplary embodiments are listed below.

80. A Method for searching one or more pools of content to identify a particular set of instructions based on item (ex. Searching recipes for chicken, or replacement instructions for a toilet ball cock.) by a consumer in a retail store and presenting product information and/or advertisements during the item search. Place the delivery system consisting of a processing unit, one or more displays, a touch screen, a storage device and a communication device inside the retail establishment in the aisles where merchandise is offered for sale. Display a graphical interface wherein a consumer operating the device can begin a search for instructions for use of a particular item. While the search is being conducted, use a database program to determine the placement of one or more advertisements or general information on products for sale in the retail establishment including on one or more layers in front of the search content. Using the database, rotate through the pool of advertisements and/or information.

81. A method according to claim 80 further including, in combination with other methods and based upon the response to the database search initiated by the user, the use of a database program to display specific advertising and/or incentives (coupons) or product information on how to buy the item(s) identified in the search response.

82. A method according to claim 80 further including, in combination with other methods and based upon the response to the database search initiated by the user and on previous selections by other users who made the same pattern of selections, the use of a database program to display specific recommendations for additional non-searched instructions (recipes), including advertising and/or incentives (coupons) or recommendation or product information on how to buy or use the item identified in the search response, including tips or techniques for use.

83. A method according to claim 80 further including, in combination with other methods, printing the instructions.

84. A method according to claim 80 further including in combination with other methods, printing specific advertising and/or printing a brand name in a printed set of instructions as a result of a database search for instructions based on item (ex. Printing “Purdue Chicken advertisement on the recipe and/or including “Purdue” Chicken in the recipe that is selected as a result of a search for chicken as an ingredient in a recipe) by a consumer in a retail store.

85. A method according to claim 80 further including in combination with other methods, recording in a database which items were searched by consumers. Transmit the results to a central collection point for analysis and dissemination to advertisers.

86. A method according to claim 80 further allowing the customer to respond to one or more market research questions and recording the answers in a database. Use the communication device to report the responses back to a central database for analysis and dissemination.

In an example, the system or method described herein (e.g., a coupon dispensing system) can include layering ad display and/or incentive offerings, or layering ad display versus incentive offerings. Exemplary embodiments are listed below.

87. A system, comprising:

a) one or more processing units;

b) at least one touch screen unit including a display and a system to detect selections made by a consumer by touching the screen unit;

c) at least one network connection;

d) at least one data storage device;

e) at least one data output device;

f) one or more computer programs operative on the one or more processing units to:

g) access a plurality of incentive offerings;

h) access a plurality of advertisements;

i) displaying incentive offerings to a consumer interacting with the touch screen unit wherein the incentive offerings change at least in part in response to an incentive offer change input received by the consumer, wherein the incentive offerings are displayed in a first area of the display of the touch screen unit and the incentive offerings are obtained from a pool of incentive offerings;

j) displaying advertising simultaneously with the incentive offerings in a different area of the display of the touch screen unit, wherein the advertising is displayed from a pool of advertising content and changed at least in part in response to the incentive offer change input.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B.” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system, comprising:
a) one or more processing units;
b) at least two touch screen units, each touch screen unit including a display and a system to detect selections made by a consumer by touching the screen unit;
c) at least one network connection;
d) at least one data storage device;
e) at least one output device;
f) one or more computer programs operative on the one or more processing units to:
g) access a plurality of incentive offerings;
h) access a plurality of advertisements;
i) respond to inputs received from respective consumers each independently interacting with the touch screen units and display at least one of the incentive offerings to the respective consumers at least in part responsive to touch inputs received from the respective consumers; and
j) display advertisements on each of the at least two touch screen units, wherein the advertisements are displayed simultaneously with the display of incentive offerings to a consumer interacting with the respective touch screen unit or at times when a consumer is not interacting with the respective touch screen unit.

2. The system of claim 1, wherein the or more computer programs are operative on the one or more processing units to output an incentive offering using the at least one output device.

3. The system of claim 2, wherein the output device includes a printer or a data transfer device.

4. The system of claim 1, including a web interface for viewing of selected output device or consumer selection data.

5. The system of claim 1, including an authoring tool for preparing coupon offering data to be used to display coupon, incentive or advertisement offerings by the dispensing devices.

6. The system of claim 1, wherein the one or more computer programs are operative on the one or more processing units to record a plurality of inputs received on the one or more touch screen displays.

7. The system of claim 6, wherein the display of incentive offerings or advertisements is based at least in part on the record of inputs received.

8. A method, comprising:
receiving touch inputs by consumers on at least two touch screen units;
displaying incentive offerings to each respective consumer at least in part in response to the received touch inputs from the respective consumers; and
displaying advertisements to each respective consumer interacting with the respective touch screen unit simultaneously with the displaying of incentive offerings.

9. The method of claim 8, including displaying products or services, and wherein the displaying the incentive offerings includes displaying incentive offerings associated with the displayed products or services.

10. The method of claim 9, wherein the displaying the advertisements includes displaying advertisements associated with the displayed products and services.

11. The method of claim 8, wherein the displaying the advertisements includes displaying advertisements associated with the incentive offerings.

12. The method of claim 8, wherein the displaying incentive offerings includes displaying a sequence of incentive offerings; and
wherein the receiving the touch inputs include at least in part input associated with advancing the sequence of incentive offerings.

13. The method of claim 8, wherein the receiving the touch inputs include receiving input indicating a preference for one of the incentive offerings and recording the incentive offerings as a preferred incentive offering.

14. The method of claim 13, including arranging a sequence of incentive offerings using the received preference so a sequence of non-preferred incentive offerings are displayed before any preferred incentive offerings.

15. The method of claim 8, including outputting a selected incentive offering; and
wherein the displaying incentive offerings includes ceasing to display the incentive offerings or substituting different incentive offerings once a threshold count on the number of times a particular incentive offerings has been output.

16. The method of claim 8, wherein displaying further includes instructions associated with the product or service.

17. A method, comprising:
receiving touch inputs by consumers on at least two touch screen units;
displaying incentive offerings to each respective consumer using the at least two touch screen units at least in part in response to the received touch inputs from the respective consumers; and
displaying advertisements on each of the at least two touch screen units at least in part in response to the received touch inputs from the respective consumers at times when a consumer is not interacting with the respective touch screen unit.

18. The method of claim 17, including displaying products or services, and wherein the displaying the incentive offerings includes displaying incentive offerings associated with the displayed products or services.

19. The method of claim 18, wherein the displaying the advertisements includes displaying advertisements associated with the displayed products and services.

20. The method of claim 17, wherein the displaying the advertisements includes displaying advertisements associated with the incentive offerings.
